(19) United States
(12) Patent Application Publication
(10) Pub. No.: US 2026/0230295 A1
(43) Pub. Date: Aug. 6, 2026

(54) INTERNET OF THINGS NON-TERRESTRIAL NETWORK TIME DIVISION DUPLEX FRAME STRUCTURE AND TIME SLOT DETERMINATION

(71) Applicant: Sharp Kabushiki Kaisha, Osaka (JP)

(72) Inventors: Zhanping Yin, Vancouver, WA (US); Tomoki Yoshimura, Camas, WA (US)

(21) Appl. No.: 19/047,419

(22) Filed: Feb. 6, 2025

(51) Int. Cl. H04L 5/14; H04W 72/0446; H04W 84/06

(52) U.S. Cl. CPC H04L 5/1469; H04W 72/0446; H04W 84/06

(57) ABSTRACT

An internet of things (IoT) non-terrestrial network (NTN) device user equipment (UE) is described. The UE includes receiving circuitry configured to determine an IoT NTN downlink (DL) timeslot within legacy time division duplex (TDD) DL slots. The UE also includes transmitting circuitry configured to determine an IoT NTN uplink (UL) timeslot within legacy TDD UL slots.

### TECHNICAL FIELD

The present disclosure relates generally to communication systems. More specifically, the present disclosure relates to systems and methods for Internet of Things (IoT) Non-Terrestrial Network (NTN) Time Division Duplex (TDD) frame structure and time slot determination.

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility, and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### BRIEF DESCRIPTION OF THE DRAWINGS

FIG. 1 is a diagram illustrating an example of a Non-Terrestrial Network (NTN) coverage area;

FIG. 2 is a diagram illustrating an example of a legacy L-band system Time Division Duplex (TDD) structure;

FIG. 3 is a table illustrating an example of legacy L-band TDD allocation;

FIG. 4 is a diagram illustrating an example of a Long-Term Evolution (LTE) Frequency Division Duplex (FDD) frame structure;

FIG. 5 is a diagram illustrating an example of an LTE slot structure with a normal Cyclic Prefix (CP);

FIG. 6 is a diagram illustrating an example of Narrowband Physical Broadcast Channel (NPBCH), Narrowband Primary Synchronization Signal (NPSS), and Narrowband Secondary Synchronization Signal (NSSS) locations in Narrowband Internet of Things (NB-IoT);

FIG. 7 is a diagram illustrating an example of LTE-NB frame structure for guardband/standalone deployment for an even radio frame, which is continued on the following figure;

FIG. 8 is a diagram illustrating an example of LTE-NB frame structure for guardband/standalone deployment for an even radio frame, which is continued on the following figure;

FIG. 9 is a diagram illustrating an example of LTE-NB frame structure for guardband/standalone deployment for an even radio frame, which is continued on the following figure;

FIG. 10 is a diagram illustrating an example of LTE-NB frame structure for guardband/standalone deployment for an even radio frame, which is continued on the following figure;

FIG. 11 is a diagram illustrating an example of LTE-NB frame structure for guardband/standalone deployment for an even radio frame, which is continued on the following figure;

FIG. 12 is a diagram illustrating an example of LTE-NB frame structure for guardband/standalone deployment for an even radio frame;

FIG. 13 is a diagram illustrating an example of LTE-NB frame structure for guardband/standalone deployment for an odd radio frame, which is continued on the following figure;

FIG. 14 is a diagram illustrating an example of LTE-NB frame structure for guardband/standalone deployment for an odd radio frame, which is continued on the following figure;

FIG. 15 is a diagram illustrating an example of LTE-NB frame structure for guardband/standalone deployment for an odd radio frame, which is continued on the following figure;

FIG. 16 is a diagram illustrating an example of LTE-NB frame structure for guardband/standalone deployment for an odd radio frame, which is continued on the following figure;

FIG. 17 is a diagram illustrating an example of LTE-NB frame structure for guardband/standalone deployment for an odd radio frame, which is continued on the following figure;

FIG. 18 is a diagram illustrating an example of LTE-NB frame structure for guardband/standalone deployment for an odd radio frame;

FIG. 19 is a diagram illustrating an example of IoT NTN UL timeslots and IoT NTN DL timeslots in the center of legacy TDD slots;

FIG. 20 is a table illustrating an example of IoT NTN TDD timeslots in the center of legacy L-band TDD DL and UL slots;

FIG. 21 is a diagram illustrating an example of IoT NTN UL timeslots and IoT NTN DL timeslots with full LTE subframes;

FIG. 22 is a diagram illustrating an example of IoT NTN UL timeslots and IoT NTN DL timeslots with nearest slot alignment;

FIG. 23 is a table illustrating an example of IoT NTN TDD timeslots with nearest LTE slot alignment;

FIG. 24 is a diagram illustrating an example of IoT NTN UL timeslots and IoT NTN DL timeslots with slot alignment and symbol level offsets;

FIG. 25 is a table illustrating an example of IoT NTN TDD timeslots with nearest LTE slot alignment and symbol offsets;

FIG. 26 is a diagram illustrating an example of different period starting points for IoT NTN TDD periods with an offset;

FIG. 27 is a diagram illustrating an example of synchronization signal mapping in an IoT NTN DL timeslot;

FIG. 28 is a diagram illustrating an example of different mapping methods for NPSS and NSSS in different periods and DL timeslots;

FIG. 29 is a flow diagram illustrating an example of a communication method by an IoT NTN device UE;

FIG. 30 is a flow diagram illustrating another example of a communication method by an IoT NTN device UE;

FIG. 31 is a flow diagram illustrating another example of a communication method by an IoT NTN device UE;

FIG. 32 is a diagram illustrating one implementation of a core network node;

FIG. 33 is a block diagram illustrating one implementation of a base station (eNB) in which the present systems and methods may be implemented;

FIG. 34 is a block diagram illustrating one implementation of a wireless terminal in which the present systems and methods may be implemented;

FIG. 35 illustrates various components that may be utilized in a wireless terminal in which the present systems and methods may be implemented;

FIG. 36 illustrates various components that may be utilized in an eNB in which the present systems and methods may be implemented;

FIG. 37 is a block diagram illustrating one implementation of a wireless terminal in which the present systems and methods may be implemented; and

FIG. 38 is a block diagram illustrating one implementation of a eNB in which the present systems and methods may be implemented.

### DETAILED DESCRIPTION

An internet of things (IoT) non-terrestrial network (NTN) device user equipment (UE) is described. The UE comprises receiving circuitry configured to determine an IoT NTN downlink (DL) timeslot within legacy time division duplex (TDD) DL slots. The UE also comprises transmitting circuitry configured to determine an IoT NTN uplink (UL) timeslot within legacy TDD UL slots.

In some examples, the IoT NTN DL timeslot and the IoT NTN UL timeslot are at the center of the legacy TDD DL and UL slots. The IoT NTN DL timeslot or the IoT NTN UL timeslot may include full subframes or full slots that fit within the legacy TDD DL and UL slots. The IoT NTN DL timeslot or the IoT NTN UL timeslot may also comprise a long-term evolution (LTE) slot boundary alignment with symbol offset for different slots.

The position of each IoT NTN DL timeslot and each IoT NTN UL timeslot may be relative to the beginning of an IoT NTN TDD 90-millisecond (ms) period. The IoT NTN TDD 90 ms period may include an offset time from a legacy L-band TDD structure, such that the period starts with all IoT NTN DL timeslots and ends with all IoT NTN UL timeslots.

An e-NodeB (eNB) is also described. The eNB comprises transmitting circuitry configured to determine an IoT NTN DL timeslot within legacy TDD DL slots. The eNB also comprises receiving circuitry configured to determine an IoT NTN UL timeslot within legacy TDD UL slots.

A method by an IoT NTN device UE is also described. The method includes determining an IoT NTN DL timeslot within legacy TDD DL slots and determining an IoT NTN UL timeslot within legacy TDD UL slots.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10, 11 and/or 12). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a wireless terminal, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a wireless terminal. However, as the scope of the present disclosure should not be limited to the 3GPP standards, the terms “wireless terminal” and “wireless communication device” may be used interchangeably herein to mean the more general term “wireless communication device.” A wireless terminal may also be more generally referred to as a terminal device.

In 3GPP specifications, a base station is typically referred to as a Node B, an evolved Node B (eNB), a home enhanced or evolved Node B (HeNB) or some other similar terminology. As the scope of the disclosure should not be limited to 3GPP standards, the terms “base station,” “Node B,” “eNB,” “gNB” and/or “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB may also be more generally referred to as a base station device.

It should be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands (e.g., frequency bands) to be used for communication between an eNB and a wireless terminal. It should also be noted that in E-UTRA and E-UTRAN overall description, as used herein, a “cell” may be defined as “combination of downlink and optionally uplink resources.” The linking between the carrier frequency of the downlink (DL) resources and the carrier frequency of the uplink resources may be indicated in the system information transmitted on the downlink resources.

“Configured cells” are those cells of which the wireless terminal is aware and is allowed by an eNB to transmit or receive information. “Configured cell(s)” may be serving cell(s). The wireless terminal may receive system information and perform the required measurements on all configured cells. “Configured cell(s)” for a radio connection may include a primary cell and/or no, one, or more secondary cell(s). “Activated cells” are those configured cells on which the wireless terminal is transmitting and receiving. That is, activated cells are those cells for which the wireless terminal monitors the physical downlink control channel (PDCCH) and in the case of a downlink transmission, those cells for which the wireless terminal decodes a physical downlink shared channel (PDSCH). “Deactivated cells” are those configured cells that the wireless terminal is not monitoring the transmission PDCCH. It should be noted that a “cell” may be described in terms of differing dimensions. For example, a “cell” may have temporal, spatial (e.g., geographical) and frequency characteristics.

Fifth generation (5G) cellular communications (also referred to as “New Radio,” “New Radio Access Technology” or “NR” by 3GPP) envisions the use of time, frequency and/or space resources to allow for enhanced mobile broadband (eMBB) communication and ultra-reliable low-latency communication (URLLC) services, as well as massive machine type communication (MMTC) like services. To meet a latency target and high reliability, mini-slot-based repetitions with flexible transmission occasions may be supported. Approaches for applying mini-slot-based repetitions are described herein. A new radio (NR) base station may be referred to as a gNB. A gNB may also be more generally referred to as a base station device.

One important objective of 5G is to enable connected industries. 5G connectivity can serve as a catalyst for the next wave of industrial transformation and digitalization, which improve flexibility, enhance productivity and efficiency, reduce maintenance cost, and improve operational safety. Devices in such environments may include, for example, pressure sensors, humidity sensors, thermometers, motion sensors, accelerometers, actuators, etc. It is desirable to connect these sensors and actuators to 5G networks and core. The massive industrial wireless sensor network (IWSN) use cases and requirements include not only URLLC services with very high requirements, but also relatively low-end services with the requirement of small device form factors, and/or being completely wireless with a battery life of several years. The requirements for these services that are higher than low power wide area (LPWA) (e.g., LTE-MTC and/or Narrowband Internet of Things (LTE-M/NB-IoT)) but lower than URLLC and eMBB.

A non-terrestrial network (NTN) refers to a network, or segment of networks using radio frequency (RF) resources onboard a satellite (or UAS platform). Non-Terrestrial Network typically features the following elements: one or several sat-gateways that connect the Non-Terrestrial Network to a public data network. For example, a Geostationary Earth Orbiting (GEO) satellite is fed by one or several sat-gateways which are deployed across the satellite targeted coverage (e.g., regional or even continental coverage). It may be assumed that wireless terminals in a cell are served by only one sat-gateway. A Non-GEO satellite served successively by one or several sat-gateways at a time. The system ensures service and feeder link continuity between the successive serving sat-gateways with sufficient time duration to proceed with mobility anchoring and hand-over.

Additionally, Non-Terrestrial Network typically features the following elements: a Feeder link or radio link between a sat-gateway and the satellite (or Unmanned Aircraft System (UAS) platform), a service link or radio link between the wireless terminal and the satellite (or UAS platform).

Additionally, Non-Terrestrial Network typically features the following elements: a satellite (or UAS platform) which may implement either a transparent or a regenerative (with onboard processing) payload. The satellite (or Unmanned Aircraft System (UAS) platform) may generate several beams over a given service area bounded by its field of view. The footprints of the beams are typically of elliptic shape. The field of view of a satellite (or UAS platform) depends on the onboard antenna diagram and min elevation angle. For a transparent payload, radio frequency filtering, frequency conversion and amplification may be applied. Hence, the waveform signal repeated by the payload is un-changed. For a regenerative payload, radio frequency filtering, frequency conversion and amplification as well as demodulation/decoding, switch and/or routing, coding/modulation may be applied. This is effectively equivalent to having all or part of base station functions (e.g., gNB) onboard the satellite (or UAS platform).

Additionally, Non-Terrestrial Network may optionally feature the following elements: Inter-satellite links (ISL) optionally in case of a constellation of satellites. This will require regenerative payloads onboard the satellites. ISL may operate in RF frequency or optical bands.

Additionally, Non-Terrestrial Network typically features the following elements: User Equipment (UE) may be served by the satellite (or UAS platform) within the targeted service area.

There may be different types of satellites (or UAS platforms): Low-Earth Orbit (LEO) satellite, Medium-Earth Orbit (MEO) satellite, Geostationary Earth Orbit (GEO) satellite, UAS platform (including High-Altitude Platform Station (HAPS) and High Elliptical Orbit (HEO) satellite). Detailed descriptions are shown in Table 1.

TABLE 1

| | | | Typical beam |
|---|---|---|---|
| Platforms | Altitude range | Orbit | footprint size |
| Low-Earth Orbit | 300-1500 km | Circular around | 100-1000 km |
| (LEO) satellite | | the earth | |
| Medium-Earth Orbit | 7000-25000 km | | 100-1000 km |
| (MEO) satellite | | | |
| Geostationary Earth | 35 786 km | Notional station | 200-3500 km |
| Orbit (GEO) satellite | | keeping position | |
| UAS platform | 8-50 km | fixed in terms of | 5-200 km |
| (including HAPS) | (20 km | elevation/azimuth | |
| | for HAPS) | with respect to a | |
| | | given earth point | |
| High Elliptical Orbit | 400-50000 km | Elliptical around | 200-3500 km |
| (HEO) satellite | | the earth | |

Typically, GEO satellites and UAS are used to provide continental, regional or local service. A constellation of LEO and MEO may be used to provide services in both Northern and Southern hemispheres. In some cases, the constellation can even provide global coverage including polar regions. For the later, this requires appropriate orbit inclination, sufficient beams generated and inter-satellite links.

Non-terrestrial networks may provide access to wireless terminal in six reference scenarios including: Circular orbiting and notional station keeping platforms, highest round trip delay (RTD) constraint, highest Doppler constraint, a transparent and a regenerative payload, one ISL case and one without ISL (Regenerative payload is mandatory in the case of inter-satellite links), fixed or steerable beams resulting respectively in moving or fixed beam foot print on the ground.

IoT NTN TDD may be used to support LTE NB-IoT using the Iridium satellite system frequency band.

For backward compatibility of existing systems, new TDD structures are needed to align with the existing TDD frame structure. The Time Division Multiplexing (TDM) frame period is maintained the same as the legacy, i.e. 90 millisecond (ms), thus, 9 LTE radio frames can be covered in a frame period. An LTE radio frame consists of 10 subframes, and each subframe consists of 2 slots. The methods to configure LTE radio frames to satisfy the IoT NTN TDD requirements should be specified.

In IoT NTN TDD, there are 4 DL slots and 4 uplink (UL) slots, each DL slot should include an IoT NTN DL timeslot with 8 LTE DL subframes, each subframe with 1 ms. Since a UE can only receive in one of the IoT NTN DL timeslots in each 90 ms period, the NB-IoT synchronization signal locations need to be modified from legacy LTE NB-IoT to fit the IoT NTN DL timeslot.

The IoT NTN DL timeslot and UL timeslot are determined within the legacy TDD DL slots and UL slots.
Method 1: An IoT NTN DL and UL timeslot at the center of legacy TDD DL and UL slots.
Method 2: An IoT NTN DL or UL timeslot includes the full subframes that can fit in the legacy DL and UL slot.
Method 3: An IoT NTN DL or UL timeslot includes full slots that can fit in each DL and UL slot.
Method 4: An IoT NTN DL or UL timeslot with LTE slot boundary alignment with symbol offset for different slots.

In all methods, the detailed position of each IoT NTN DL timeslot and each IoT NTN UL timeslot in relative to the beginning of the IoT NTN TDD 90 ms period should be specified.

Furthermore, an IoT NTN TDD period may have an offset time from the legacy L-band TDD structure, so that the resulting period starts with all IoT NTN DL timeslots, and ends with all IoT NTN UL timeslots.

The systems and methods below may determine the relative location of synchronizations signals in an IoT NTN DL timeslot. Example approaches are as follows:
The Narrowband Physical Broadcast Channel (NPBCH) is mapped to subframe 0, and Narrowband Primary Synchronization Signal (NPSS) is mapped to subframe 4 of an IoT NTN DL timeslot.
The position of Narrowband Secondary Synchronization Signal (NSSS), if present, is determined by the number of full subframes in an IoT NTN DL timeslot.
   If there are 8 full subframes in the IoT NTN DL timeslot, NSSS is mapped to subframe 7.
   If there are only 7 full subframes in the IoT NTN DL timeslot, NSSS is mapped to subframe 6.
   Alternatively, NSSS is mapped to subframe 6 in all cases.

Additional design considerations for synchronization signal positions in a DL timeslot are as follows:
In one design, the same NPBCH, NPSS, and NSSS positions are used in all IoT NTN DL slots.
In another design, different NPBCH, NPSS, and NSSS positions are used in different IoT NTN DL timeslots. And the timeslot index can be identified by the unique mapping of NPBCH, NPSS, and NSSS positions in an IoT NTN DL timeslot.

Depending on the desired detection time, different synchronization density can be used. Several methods can be considered for the mapping of different synchronization signals in different timeslots and periods.
Method 1: NPBCH, NPSS, and NSSS in every IoT NTN DL timeslot in a period.
Method 2: NPBCH, NPSS in every period, and NSSS in every two periods for an IoT NTN DL timeslot.
   Option 1: for all IoT NTN DL timeslots, the NSSS is present in 90 ms periods with an even number of period indexes, and NSSS is not present in 90 ms periods with an odd number of period indexes (i.e. periods with indexes 2n+1).
   Option 2: the NSSS presence is alternatively switched between different IoT NTN DL timeslots in a 90 ms period.
      In 90 ms periods with an even number of period indexes, the NSSS is present in IoT NTN DL1 and DL3 timeslots, and NSSS is not present in IoT NTN DL2 and DL4 timeslots.
      In 90 ms periods with an odd number of period indexes, the NSSS is present in IoT NTN DL2 and DL4 timeslots, and NSSS is not present in IoT NTN DL1 and DL3 timeslots.

Furthermore, the first 3 symbols in the mapped subframes for NPBCH and/or NPSS and/or NSSS may be used for IoT NTN TDD. This provides more resources for the synchronization signals and improves the performance.
The number of additional mapping symbols may be 1 or 2 or all 3 symbols.

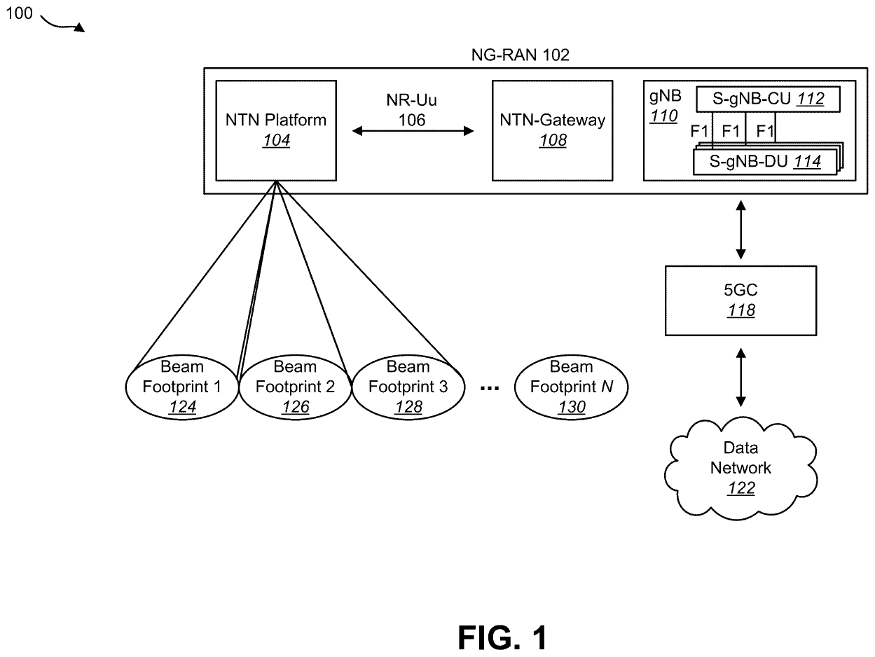

FIG. 1 is a diagram 100 illustrating an example of a non-terrestrial network (NTN) coverage area with a plurality of beams. The Next Generation Radio Access Network (NG-RAN) 102 includes an NTN-Platform 104 in communication with an NTN-Gateway 108 through a 5G air interface, such an NR-Uu 106 (New Radio User Equipment (UE) to the NR Node B (gNB) radio interface). The NG-RAN 102 also includes a base station device (gNB) 110. The gNB 110 includes an S-gNB-CU (Secondary gNodeB Control Unit) 112 and an S-gNB-DU (Secondary gNodeB Distributed Unit) 114 in communication with each unit via F1 interfaces.

The NTN coverage area includes a plurality of beams having footprints: beam footprints 1, 2, 3, . . . . N (124, 126, 128, 130). The 5G Core network (5GC) 118 is in communication with the NG-RAN 102 and a data network 122, such as a global communications network or other data network.

### Background on IoT NTN TDD

This description proposes the introduction of a new feature that allows the operator to use the radio resources in a periodic subset of the UL and DL subframes in N radio frames to achieve TDD operation in the SAN (Satellite Access Node) and IoT NTN UE, thus limiting power consumption. This feature allows extending 3GPP NB-IoT NTN operation with support for an additional NGSO satellite system.

The new feature will extend the deployment of NB-IoT NTN, by extending support to additional existing, in-orbit satellite resources, in particular additional existing Non-Geostationary Satellite Orbit (NGSO) systems, and including enabling additional lower-complexity satellite payloads, such as implementations without diplexer. With this proposed feature, there is a significant opportunity to further expand global NB-IoT NTN service coverage. This includes providing connectivity to polar regions.

This new feature should be designed to leverage commonalities with the NB-IoT frequency division duplex (FDD) NTN operation, for NGSO operating in 1616-1626.5 MHz, assuming this band will be defined as an unpaired spectrum in 3GPP. This will define a TDD mode for NB-IoT NTN systems. The feature is not intended to be applicable to existing 3GPP bands.

The work item aims to specify enhancements for NB-IoT NTN to enable NTN operation with a NB-IoT TDD mode leveraging commonalities with half-duplex NB-IoT FDD NTN, by defining a new NB-IoT TDD mode for NTN based on minimum necessary changes to the NB-IoT NTN FDD frame structure and procedures for the NB-IoT operation in the targeted unpaired mobile satellite service (MSS) allocated band (TN deployment is not expected in this band). The feature is not intended to be applicable to existing 3GPP bands.

The work objectives assume the following:
LEO @600 km and @ 1200 km orbit respectively, with set-1 satellite parameters as reference scenarios (See 3GPP TR 36.763).
Target the 1616-1626.5 MHz MSS allocated band.
Standalone deployment with anchor and non-anchor carriers (i.e. operating in carrier(s) used only for NB-IoT).
Operate with Earth fixed Tracking area, with either Earth fixed cells or Earth moving cells for NGSO.
The new NB-IoT NTN TDD mode allows configuring the usage of radio resources in the targeted MSS allocated band with a periodic subset of the UL and DL subframes in N radio frames. The periodic pattern should consist of non-overlapping set of usable contiguous UL subframes (U) and set of usable contiguous DL subframes (D), and guard periods, which is periodic every N radio frames, with N=9 for the target MSS allocated band.

This work item includes the following objectives:
Specify a new NB-IoT TDD NTN mode based on minimum necessary changes to the NB-IoT NTN FDD frame structure and procedures, including:
   Definition, configuration (if needed), and signaling (if needed) of the periodic pattern, necessary adaptation (if needed) and associated UE procedures [RAN1, RAN2].
      Support a pattern with a period of 9 radio frames for the target MSS allocated band, where D=U=8 with a fixed guard period. RAN1 to consider whether there is a need for a mechanism to achieve an adjustable guard period for the purpose of allowing deployment with the TDD frame structure of the legacy system operating in the target MSS allocated band.
   Other necessary impacts on higher layers [RAN2].
   RRM and RF core requirements [RAN4].
Specify a new NB-IoT TDD operating NTN band for the MSS allocation spanning 1616-1626.5 MHz for DL and UL, based on the outcome of the study, to be used as example band for this WI [RAN4].
   Specify band numbering.
   Specify SAN and UE RF characteristics.
   Specify DL and UL channelization.
   Specify channel bandwidth as 200 kHz.
   Note 1: No NTN-NTN coexistence study needed.
   Note 2: Leverage existing work as much as possible for TN-NTN coexistence of adjacent bands.
   Note 3: Reuse the existing RAN4 requirements as much as possible (no intention to have any relaxation of the RF emissions requirements).

### Legacy Iridium TDD Frame Structure

The legacy L-band system employs a time domain duplex (TDD) approach wherein it transmits and receives in an allotted time window within the frame structure.

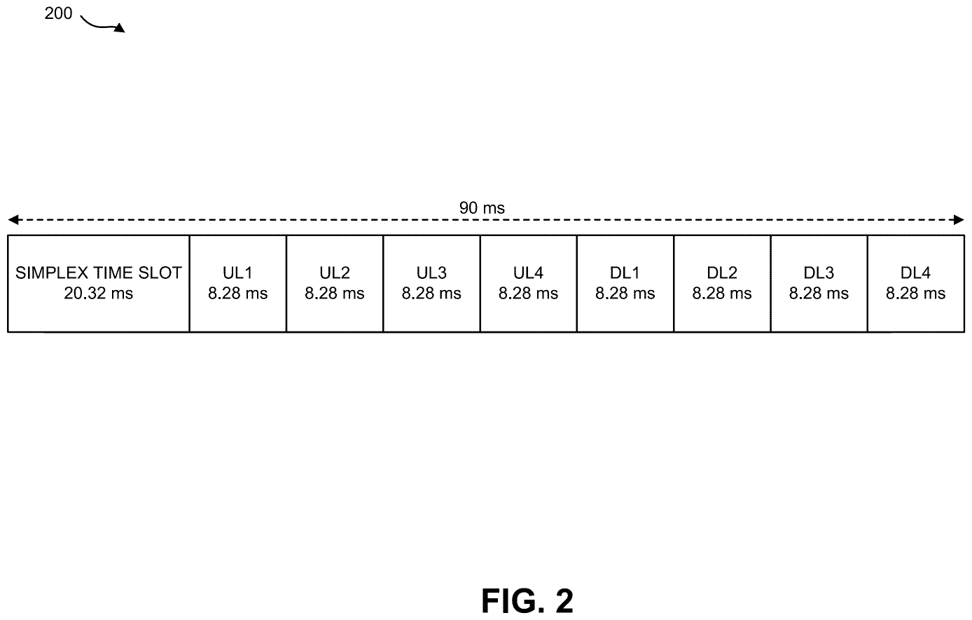

The fundamental unit of the TDMA channel is a time-slot. Time-slots are organized into frames. The frame consists of a 20.32 millisecond downlink simplex time-slot, followed by four 8.28 millisecond uplink time-slots and four downlink time-slots, which provide the duplex channel capability. The TDMA frame also includes various guard times to allow hardware set up and to provide tolerance for uplink channel operations. The L-Band subsystem TDMA frame is illustrated in FIG. 2. FIG. 2 shows the timeslots only, guard times are applied between the timeslots within a period.

FIG. 2 is a diagram 200 illustrating an example of a legacy L-band system TDD structure. Since the system is TDD, the subscriber units transmit and receive in the same frequency band. The access technology is a Frequency Division Multiple Access/Time Division Multiple Access (FDMA/TDMA) method whereby a subscriber is assigned a channel composed of a frequency and time slot in any particular beam. Channel assignments may be changed across cell/beam boundaries and are controlled by the satellite. Channels are implemented in the Iridium system using a hybrid TDMA/FDMA architecture based on TDD using a 90 millisecond frame. Channels are reused in different geographic locations by implementing acceptable co-channel interference constraints. A channel assignment comprises of both a frequency carrier and a time slot.

The simplex time-slot supports the downlink-only, ring, and messaging channels. A 12-frequency access band is reserved for the simplex (ring, alert, and messaging) channels. These channels are located in a globally allocated 500 kHz band between 1626.0 MHz and 1626.5 MHz. These frequency accesses are only used for downlink signals and they are the only L-Band frequencies that may be transmitted during the simplex time-slot. Four messaging channels and one ring alert channel are available during the simplex time-slot.

The Acquisition, Synchronization, and Traffic channels use the uplink time-slots. The Broadcast, Synchronization, and Traffic channels use the downlink duplex time-slots. The L-Band frame provides 2250 symbols per frame at the channel burst modulation rate of 25 ksps. A 2400 bps traffic channel uses one uplink and one downlink time-slot each frame.

The fundamental unit of frequency in the FDMA structure is a frequency access that occupies a 41.667 kHz bandwidth. Each channel uses one frequency access. The frequency accesses are divided into the duplex channel band and the simplex channel band. The duplex channel band is further divided into sub-bands. The frequency accesses used for duplex channels are organized into sub-bands, each of which contains eight frequency accesses. Each sub-band, therefore, occupies 333.333 kHz (8×41.667 kHz). In duplex operation, the Iridium system is capable of operating with up to 30 sub-bands, containing a total of 240 frequency accesses.

The Iridium system reuses duplex channels from beam to beam when sufficient spatial isolation exists to avoid interference. Channel assignments are restricted so that interference is limited to acceptable levels. The minimum group of duplex channels that can be allocated to an antenna beam is called a reuse unit pair. A reuse unit consists of one time-slot and the eight contiguous frequency accesses of a sub-band for a total of eight channels. The frequency accesses are numbered 1 through 8 from lowest to highest frequency. A reuse unit pair consists of an uplink reuse unit and a downlink reuse unit. Reuse unit pairs can be assigned to a beam, reclassified or activated/deactivated at the beginning of L-band frames. Dynamic beam assignment and reclassification are used to provide additional capacity to beams that have heavy traffic loading.

The IRIDIUM network utilizes multiple spot beams on each satellite that divide the satellite footprint into smaller cells. Each IRIDIUM satellite has three phased array antennas with 16 spot beams for a total of 48 spot beams on the satellite. A spot beam, like a cell in a typical cellular network, is assigned a fraction of the available frequency channels. Frequency channels can be reused throughout the network by assigning them to cells that are far enough apart to minimize co-channel interference.

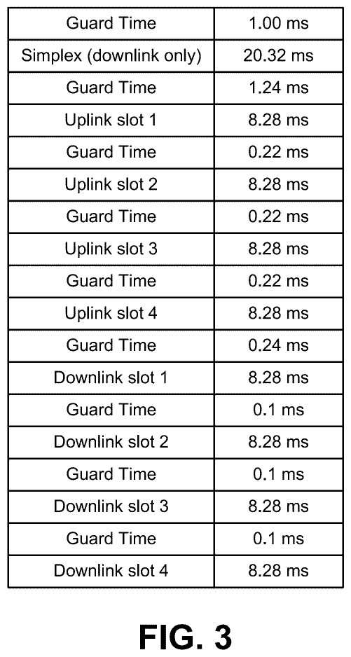

The detailed 90 ms TDMA frame structure is listed in the table in FIG. 3 with the duration of each slot and guard time. FIG. 3 is a table illustrating an example of legacy L-band TDD allocation. The detailed signal formats in simplex slot and DL slots and UL slots are not listed because they are not used and not compatible with IoT NTN DL and UL formats.

### LTE NB-IoT LTE FDD Frame Structure

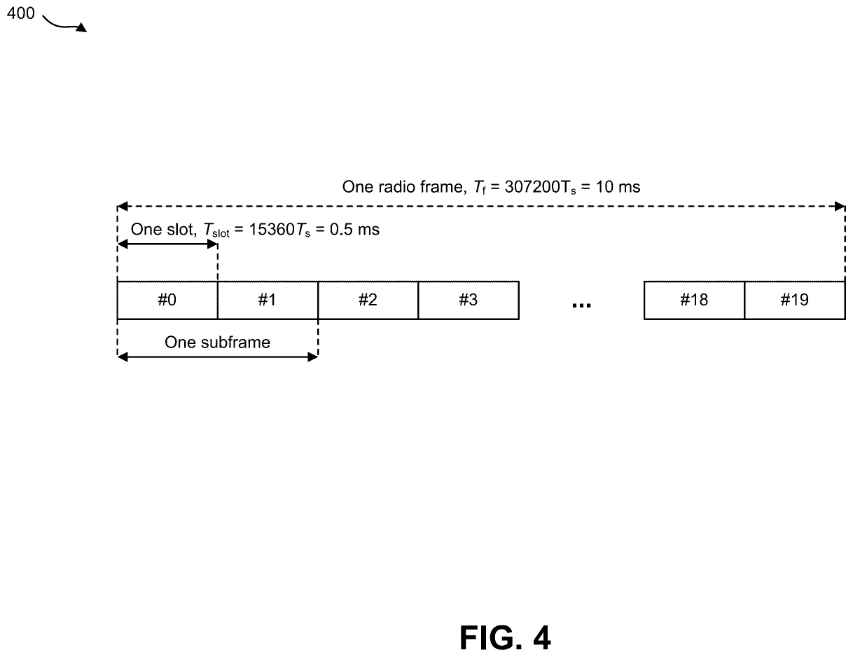

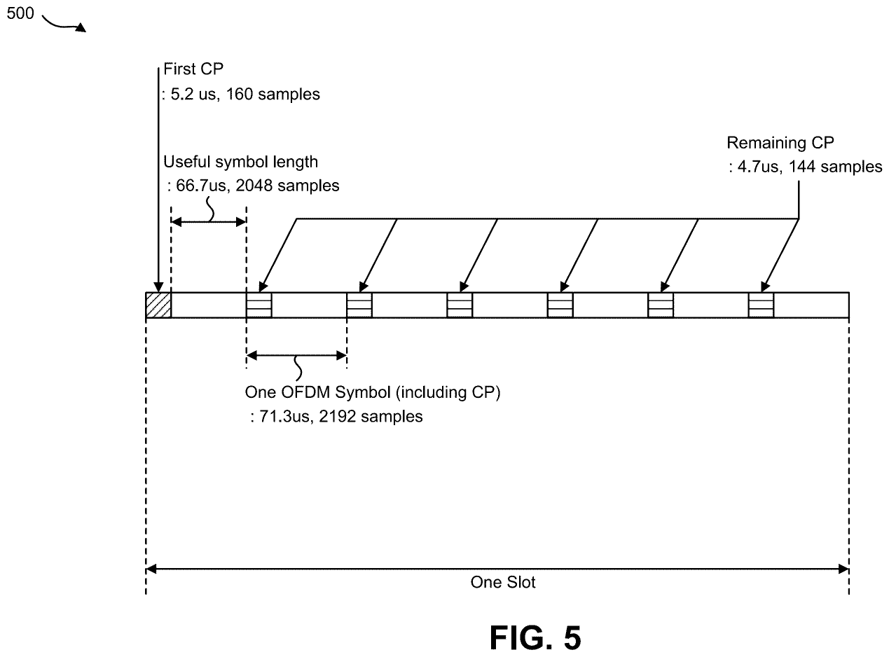

LTE Frame structure type 1 is applicable to both full duplex and half duplex frequency division duplex (FDD) only. Each radio frame is T_{f}=307200·Tₛ=10 ms long and consists of 10 subframes of length 30720·Tₛ=1 ms, numbered from 0 to 9, as shown in FIG. 4. FIG. 4 is a diagram 400 illustrating an example of LTE FDD frame structure. With normal cyclic prefix, each slot consists of 7 Orthogonal Frequency Division Multiplexing (OFDM) symbols. The cyclic prefix (CP) of the first symbol is a little longer than the CPs of other symbols, as shown in FIG. 5, which is a diagram 500 illustrating an example of LTE slot structure with normal CP.

LTE-NB downlink frame structure has some commonalities with the legacy LTE FDD frame structure, e.g. the length of a subframe is 1 ms, one radio frame is made up of 10 subframes, and the number of subcarriers within a resource block (RB) is 12. However, there are some characteristics of LTE-NB which are different from the legacy LTE, e.g. the system Bandwidth is always 180 Khz, and the number of RB within a system bandwidth is always 1.

Uplink waveform in LTE-NB is the same as in legacy LTE uplink, i.e. SC-FDMA. But there are some differences between LTE-NB and legacy LTE in terms of structure of uplink signal. In addition, there is a new unit called RU (Resource Unit) that exists in LTE-NB but not used in legacy LTE. NB-IoT uplink data NPUSCH supports 3.75 kHz SCS and 15 kHz SCS. The basic structure is defined at slot level instead of subframe level.

Narrowband Physical Random Access Channel (NPRACH) uses less bandwidth which is 180 KHz. NPRACH preambles use single tone transmissions with frequency hopping. NPRACH uses 3.75 kHz SCS, and supports two NPRACH formats, NPRACH format 0 uses CP duration of 66.67 μs and NPRACH format 1 uses CP duration of 266.7 μs. One NPRACH preamble consists of 4 symbol groups with each symbol group having 1 CP and 5 symbols. Frequency index of symbol groups follow frequency hopping patterns. Thus, the basic TTI is 5.6 ms or 6.4 ms for NPRACH.

Synchronization signals for legacy LTE NB-IoT

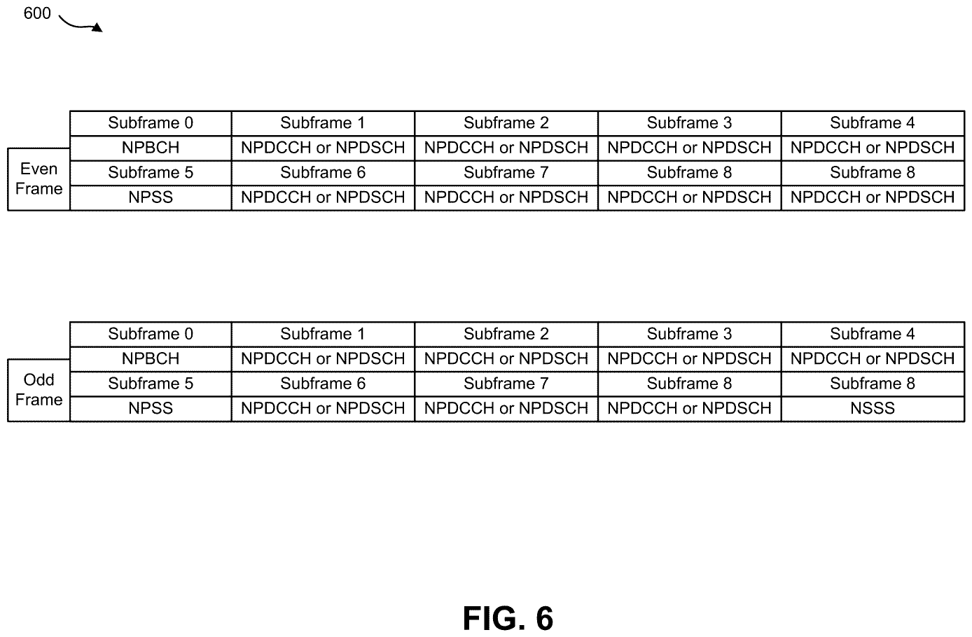

The synchronization signals for NB-IoT are very different from legacy LTE. In NB-IoT, the NPSS and NSSS are located in different subframes, whereas PSS and SSS in legacy LTE are located in the same subframes. The NPSS is transmitted in every radio frame but NSSS is transmitted in every two radio frames (in even frame), as shown in FIG. 6, whereas both PSS and SSS are transmitted in every radio frame in legacy LTE.

FIG. 6 is a diagram illustrating an example of NPBCH, NPSS, and NSSS locations in NB-IoT.

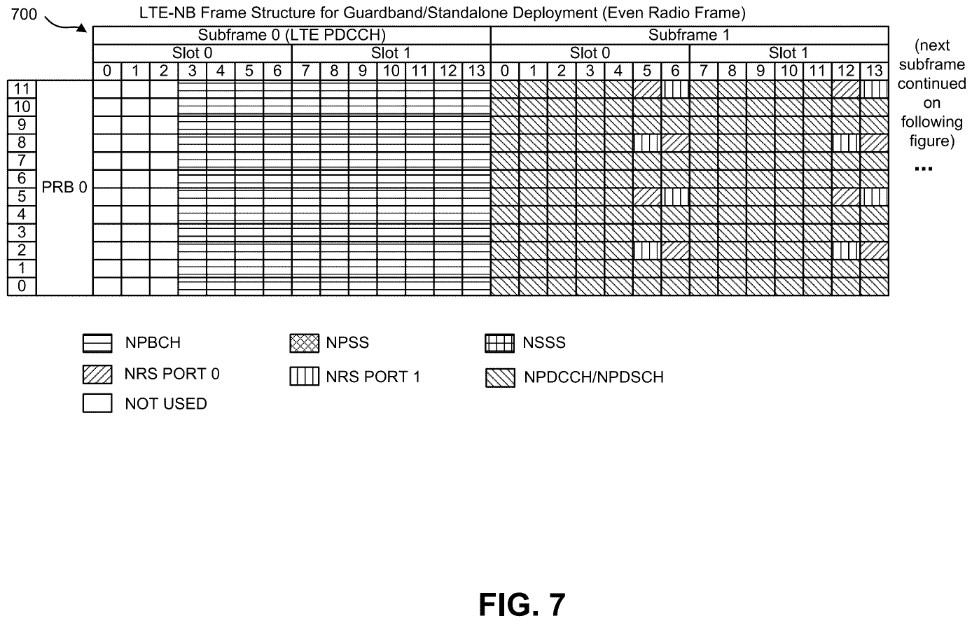

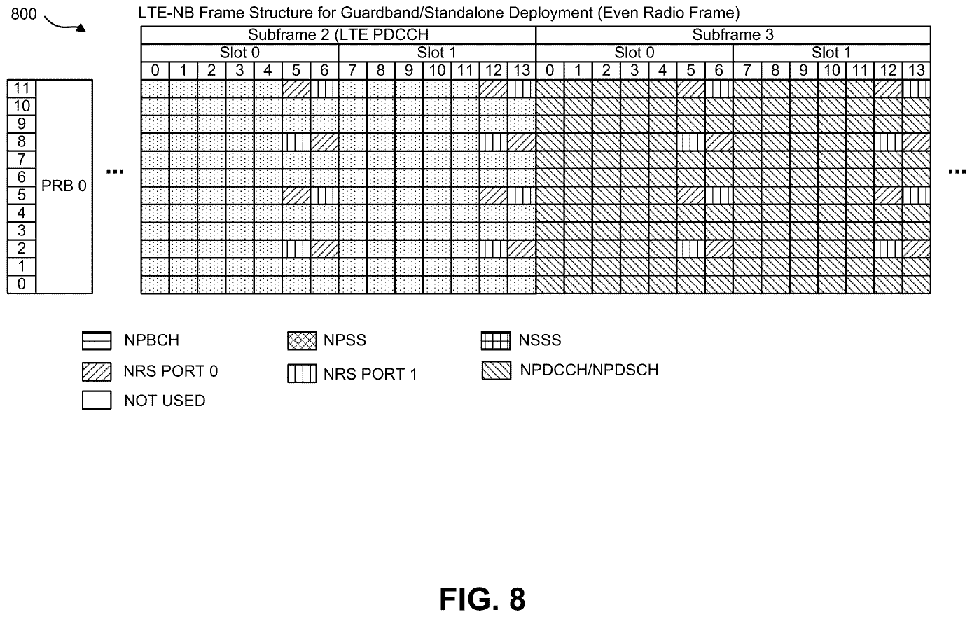

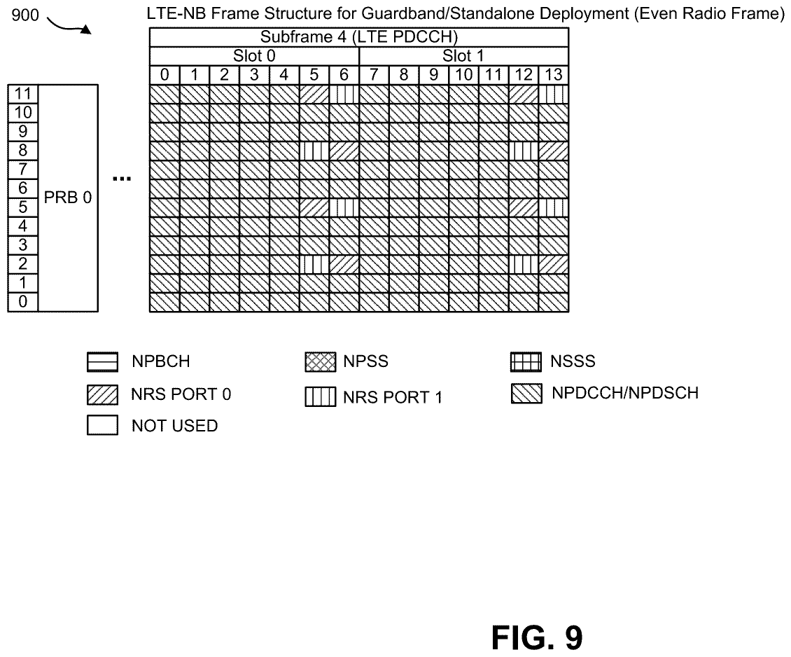

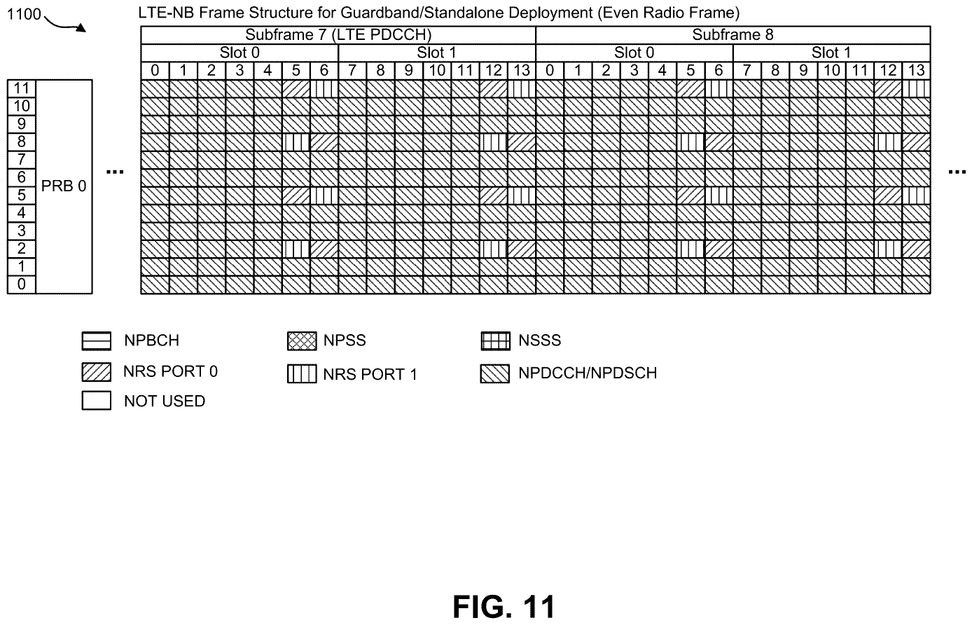

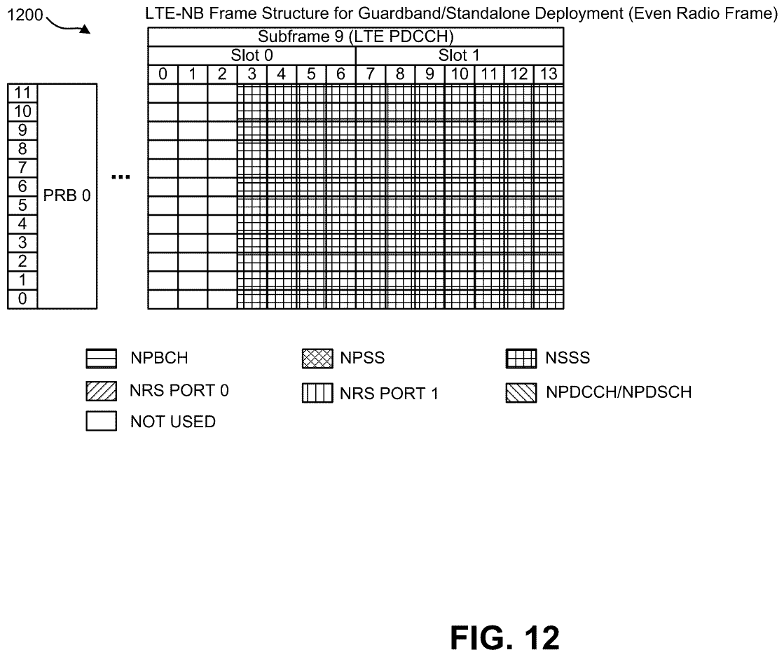

For IoT NTN TDD, since there is no legacy LTE network in the frequency band, the NB-IoT standalone deployment should be used. In this case, no legacy LTE reference signals, such as cell-specific reference signals (CRS), are needed. And no legacy LTE PDCCH region is reserved in a subframe. The detailed mappings for the synchronization signals in standalone deployment are shown in FIGS. 7-12.
NPBCH occupies a whole subframe except the first three symbols at subframe 0.
NPSS occupies a whole subframe except the first three symbols and the last subcarrier at subframe 5 of every radio frame.
NSSS occupies a whole subframe except the first three symbols and the last subcarrier at subframe 9 of every even radio frame.

FIGS. 7-12 are diagrams (700-1200) illustrating an of example of LTE-NB frame structure for guardband/standalone deployment for an even radio frame.

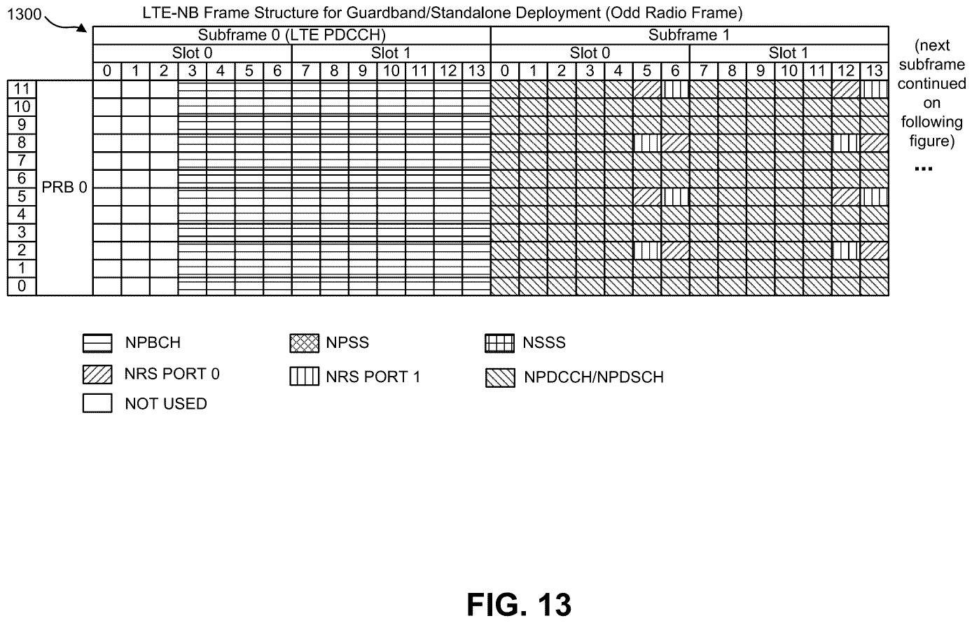

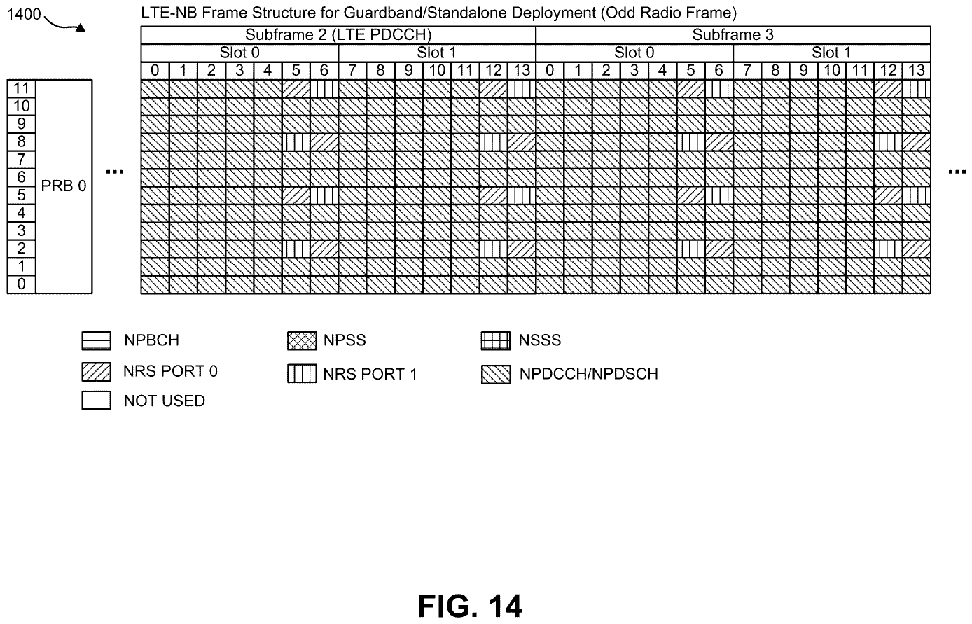

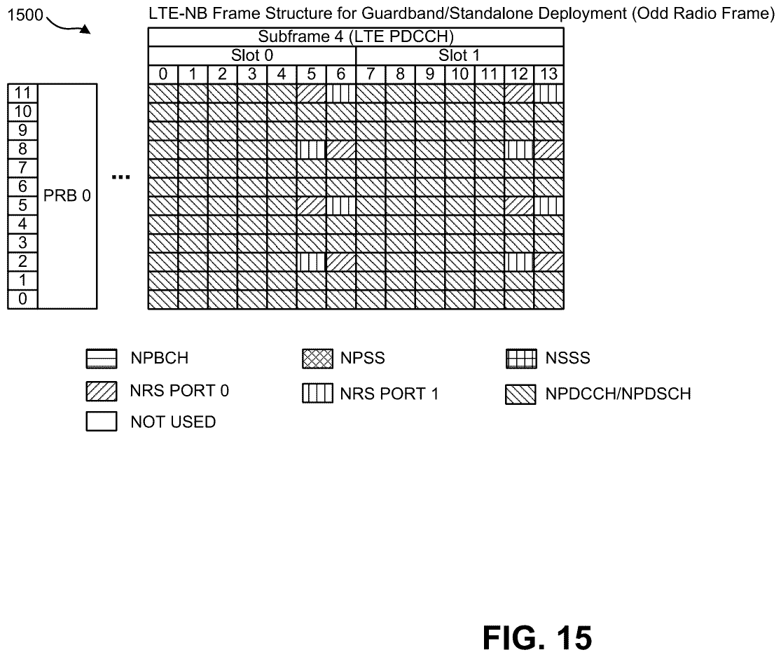

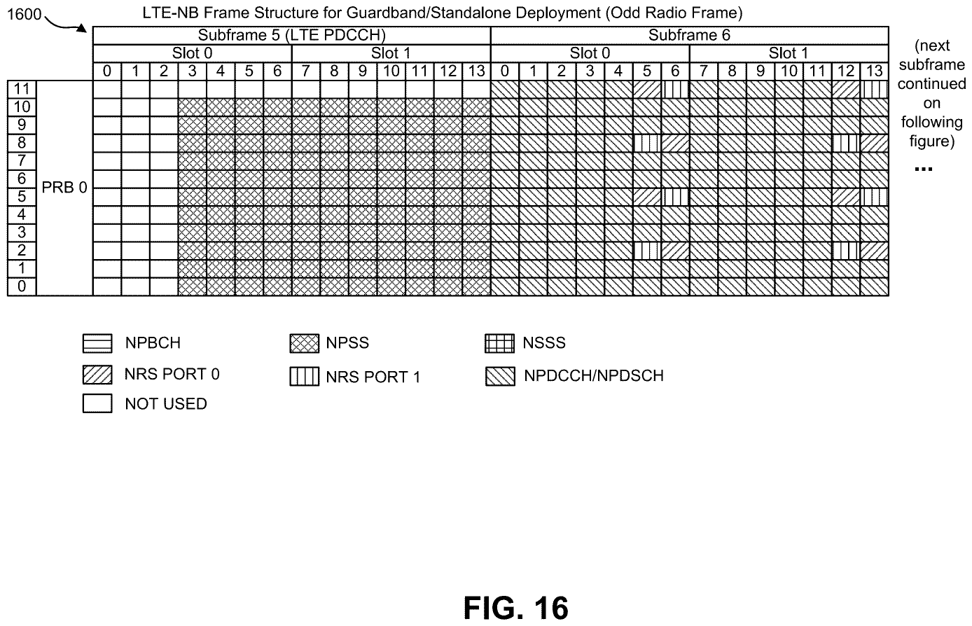

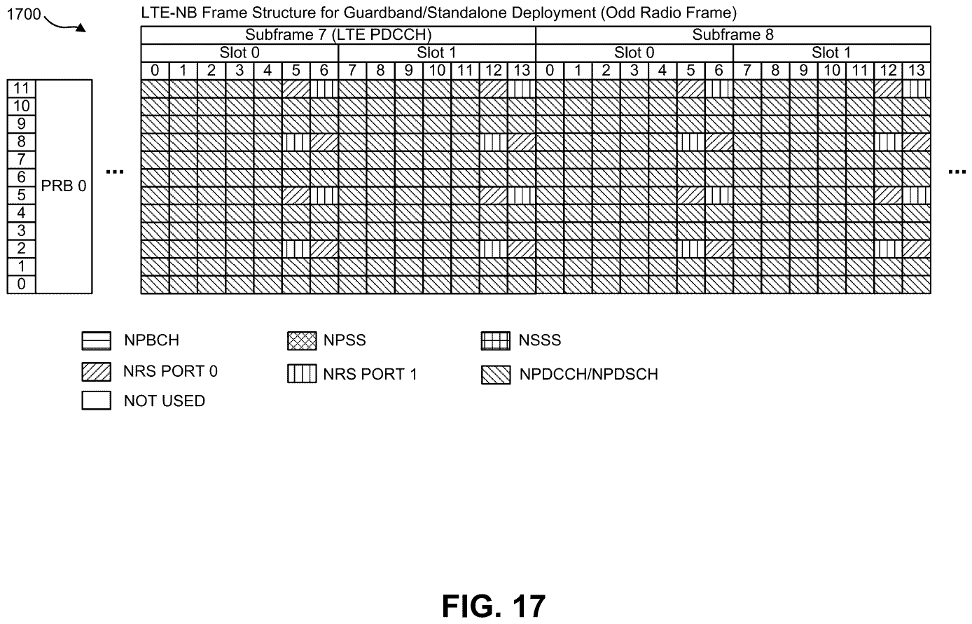

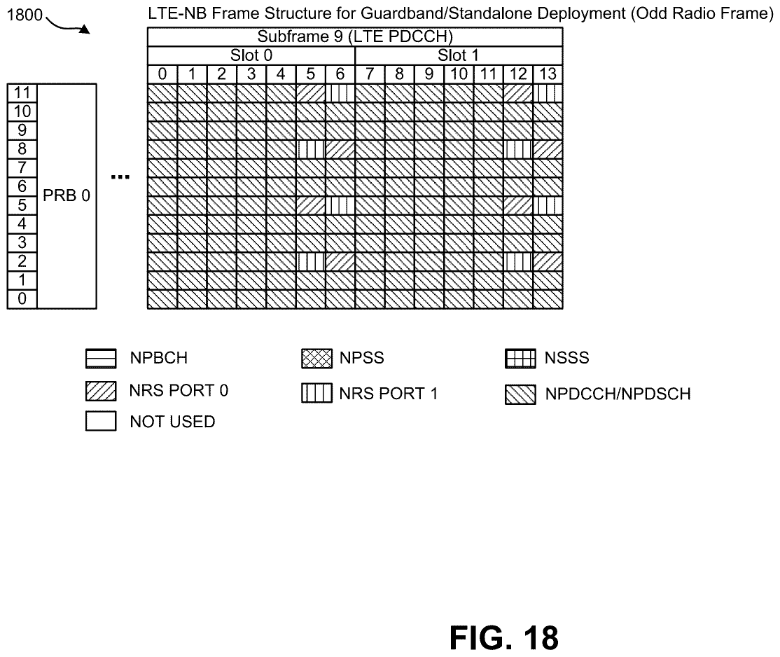

FIGS. 13-18 are diagrams (1300-1800) illustrating an example of LTE-NB frame structure for guardband/standalone deployment for an odd radio frame.

### Issue 1: IoT NTN TDD Frame Structure and Time Slot Determination

Regarding operation within the same band as the TDD frame structure of legacy system in the 1.6 GHz MSS band (shown below), the following design constraints should be considered.
At the satellite, all downlink NB-IoT channels/signals in a cell can only use one of the downlink slots in the TDD frame structure (DL1, DL2, DL3 or DL4) across 90 ms periods.
   The same downlink slot is used in all the 90 ms periods.
At the satellite, all uplink NB-IoT channels in a cell can only use one of the uplink slots in the TDD frame structure (UL1, UL2, UL3 or UL4) across 90 ms periods.
   The same uplink slot is used in all the 90 ms periods.
The one uplink slot and one downlink slot in the TDD frame structure have the same index (DL1 & UL1, DL2 & UL2, DL3 & UL3, or DL4 & UL4).
NOTE: this does not imply that the only configuration(s) to be specified are according to these constraints.

For the system design, at least D=8 and U=8 is feasible with N=9 from point of view of the design constraints (from earlier agreement) imposed by the TDD frame structure of the legacy system in the 1616-1626.5 MHz MSS band, where D=8 means 8 ms with a set of 8 consecutive DL subframes, and U=8 means 8 ms with a set of 8 consecutive UL subframes, and N=9 means the period is 90 ms which consists of 9 radio frames, and each radio frame is 10 ms as in legacy LTE.

Based on the design constraints above, the standard should first specify how to define the D=8 and U=8 subframe sets that can fit in the legacy TDD frame structure.

An IoT NTN DL subframe set may also be known as an IoT NTN DL slot, an IoT NTN DL timeslot, and an IoT NTN DL subset, an IoT NTN DL instance or an IoT NTN DL interval, etc. An IoT NTN UL subframe set may also be known as an IoT NTN UL slot, an IoT NTN UL timeslot, and an IoT NTN UL subset, an IoT NTN UL instance or an IoT NTN UL interval, etc. In the remaining context, IoT NTN DL timeslot and IoT NTN UL timeslot will be used to differentiate from legacy DL slot and legacy UL slot as well as LTE DL slot and LTE UL slot.

As shown before in the legacy L-band TDD frame structure with a period is 90 ms. Each legacy DL slot or legacy UL slot is 8.28 ms, not an integer value, and not aligned with LTE subframe boundaries. Furthermore, guard times are used between each legacy DL or legacy UL slots, and the guard time durations are different: the guard time is 0.22 ms between 2 legacy UL slots, the guard time is 0.1 ms between 2 legacy DL slots, the guard time is 0.22 ms between 2 legacy UL slots 0.24 ms between legacy UL slot U4 and legacy DL slot D1. The guard times are not consistent and not aligned with a subframe or slot or symbol durations either, which introduce additional shifts or offsets for LTE subframe alignments.

The simplex timeslot in legacy system occupies a 0.5 MHz sideband, and is not used for data traffic transmissions. The duplex region occupies the target 10 MHz bandwidth are used for data traffic, more specifically DL slots D1 to D4 for DL transmissions and UL slots U1 to U4 for UL transmissions. Thus, in the context below, the focus is how to define the IoT NTN DL timeslots and IoT NTN UL timeslots to better align with the legacy TDD frame structure.

Several methods may be considered:

### Method 1: IoT NTN DL and UL Timeslots at the Center of Legacy TDD DL and UL Slots

Note that each legacy DL slot or legacy UL slot is 8.28 ms, which is more than 8 ms for 8 full LTE subframes, the remaining 0.28 ms is less than 4 LTE symbols, thus up to 3 LTE symbols may be transmitted even if the whole legacy DL slot or legacy UL slot is used. Since D=8 and U=8 are used for the system design, the additional 0.28 ms may be ignored in most cases.

Thus, an IoT NTN DL timeslot can be defined by the center 8 ms of a legacy TDD DL slot, and an IoT NTN UL timeslot can be defined by the center 8 ms of each legacy TDD UL slot. The same DL1-DL4 and UL1-UL4 timeslot indexes can be maintained. This will provide 4 IoT NTN DL timeslots with 8 ms duration corresponding to the legacy 8.28 ms DL slots, and 4 IoT NTN UL timeslots with 8 ms corresponding to the legacy 8.28 ms UL slots.

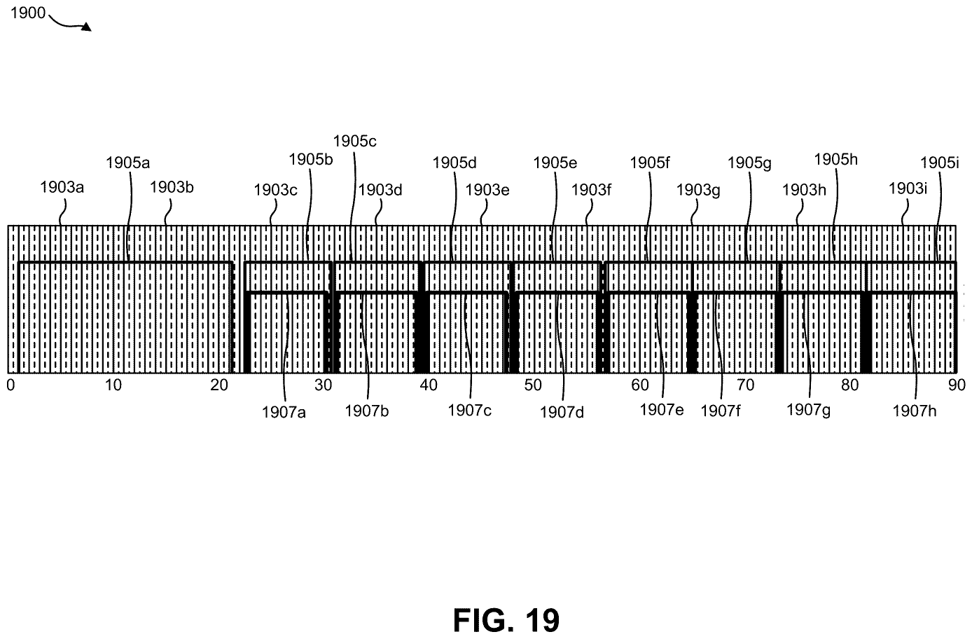

FIG. 19 shows the resulting timeslots. FIG. 19 is a diagram 1900 illustrating an example of IoT NTN UL timeslots and IoT NTN DL timeslots in the center of legacy TDD slots.
Boxes 1903a-1903i are a radio frame, which consists of 10 subframes, where a subframe is a smaller box. A subframe consists of two slots. The dashed line in each small box is the slot boundary in a subframe.
Boxes 1905a-1905i are the legacy TDD frame structures including a simplex time slot, 4 UL slots, and 4 DL slots with varies guard times in between.
Boxes 1907a-1907h are the IoT NTN UL timeslots and IoT NTN DL timeslots that are located at the center of legacy TDD UL slots and DL slots respectively. The simplex timeslot region is not shown for the IoT NTN TDD structure since it cannot be used for data transmissions in legacy TDD.

As shown in FIG. 19, none of the resulting IoT NTN UL timeslots and IoT NTN DL timeslots align with a subframe boundary or a slot boundary.

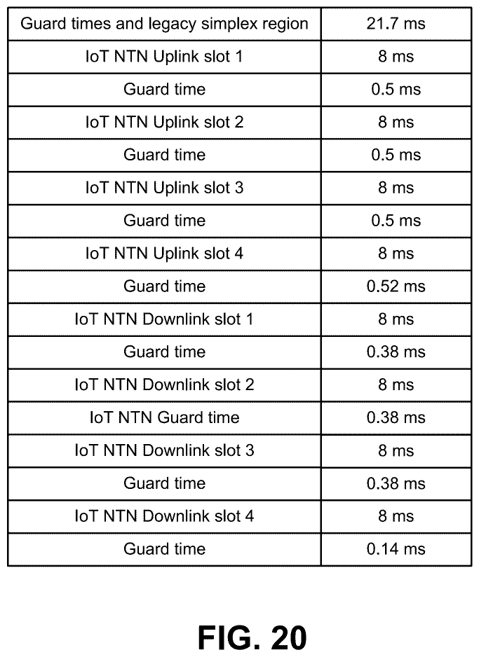

As an example, FIG. 20 shows the detailed position of each DL and UL timeslot relative to the beginning of the legacy 90 ms period when the timeslots are in the center of legacy slots. FIG. 20 is a table illustrating an example of IoT NTN TDD timeslots in the center of legacy L-band TDD DL and UL slots. None of the resulting IoT NTN DL timeslots and IoT NTN DL timeslots are aligned with the subframe or slot, or even symbols in the LTE structure.

As alternatives or variations, the U=8 and D=8 IoT NTN UL timeslots and IoT NTN DL timeslots may be shifted within the legacy TDD UL and DL slots, e.g.:
The U=8 and D=8 IoT NTN UL timeslots and IoT NTN DL timeslots may be aligned with the end of each legacy TDD UL slot and legacy TDD DL slot.
The U=8 and D=8 IoT NTN UL timeslots and IoT NTN DL timeslots may be aligned with the start of each legacy TDD UL slot and legacy TDD DL slot.
Each U=8 and D=8 IoT NTN UL timeslot and each IoT NTN DL timeslot may be shifted with different time values as long as the resulting timeslot is still within the corresponding legacy TDD slot.

In all cases, because the time within the 90 ms period and the duration of each timeslot are fixed, at least the starting point of each resulting IoT NTN DL timeslot and each IoT NTN UL timeslot should be specified. The starting position can be specified by a time value relative to the start of the 90 ms period, similar to FIG. 20 with different values. The starting position can be specified by a combination of subframe index in the 90 ms period and an offset value.

This method provides best backward compatibility for Iridium satellite operations. However, the resulting IoT NTN DL timeslots and IoT NTN UL timeslots will not align with the LTE subframe and radio frame boundaries within each 90 ms period.

Method 2: An IoT NTN DL or UL Timeslots Include Full Subframes that can Fit in Each DL and UL Slot

In another method, the LTE frame structure is maintained, and the usable subframes are defined by the overlapping parts with the legacy DL slot or UL slot.

Since the subframe boundaries are not aligned with the legacy DL slot and UL slot, if the existing LTE subframe is kept without shifting, there may be 8 full subframes or 7 full subframes in a DL or UL slot. This makes it so that the NTN DL or UL slot cannot satisfy D=8 or U=8 designs, and becomes unusable in some cases.

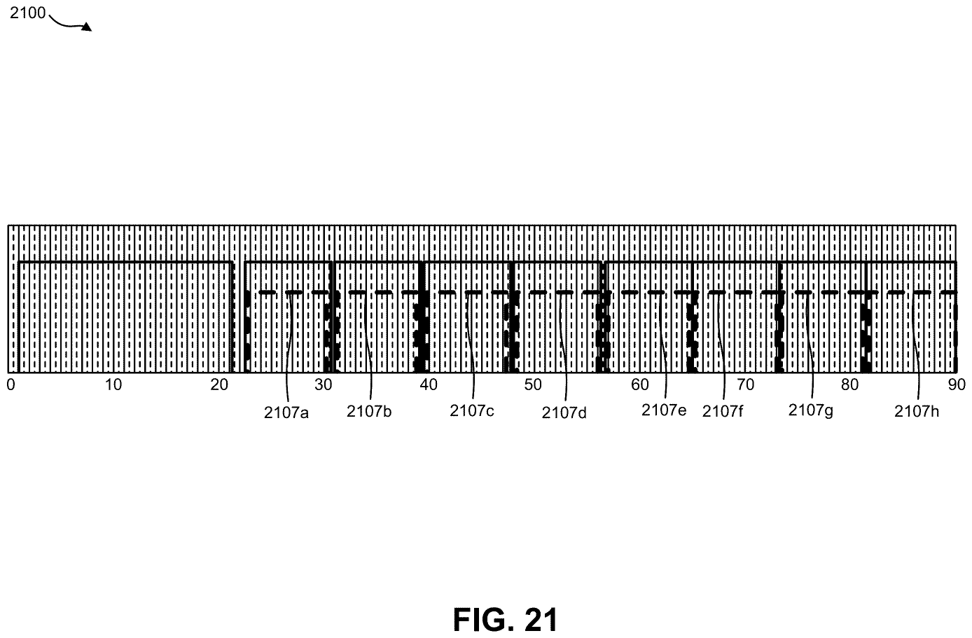

FIG. 21 is a diagram 2100 illustrating an example of IoT NTN UL timeslots and IoT NTN DL timeslots with full LTE subframes. As shown in FIG. 21, boxes 2107a-2107 h include all full subframes in each legacy DL or UL slot. With granularity of a 1 ms subframe, the guard periods will be at least 1 ms. The resulting IoT NTN DL or UL timeslot may have 8 or 7 full subframes. In most cases, only 7 full subframes are fully confined in a legacy UL slot or a legacy DL slot.

All UL slots only have 7 full subframes only. The UL2 and UL4 are only 0.06 ms short at the beginning to have 8 full subframes, virtually one symbol missing to confine in the legacy UL2 and UL4 respectively. Thus, some shift or offset may be beneficial to ensure the required number of subframes can be allocated. Alternatively, the shift can be performed by indicating a TA offset for the transmissions in a UL slot. Among 4 IoT NTN DL timeslots, DL1 and DL3 will have only 7 full subframes, and DL2 and DL4 can have 8 full subframes.

There are some overlapping partial LTE subframes or LTE symbols for each DL or UL slot, how to utilize them should be further studied. That is:
How to handle the overlap of NPUSCH with non-U NB-IoT subframes and the overlap of NPRACH (including NPRACH occasions) with non-U NB-IoT subframes?
How to handle the overlap of Narrowband Physical Downlink Control Channel/Narrowband Physical Downlink Shared Channel (NPDCCH/NPDSCH) (other than the one carrying SIB1-NB) (including e.g. starting point, windows for SI or RAR and other window sizes for DL channels/signals, PO, etc.) with non-D NB-IoT subframes?
   Method 3: An IoT NTN DL or UL Timeslots Include Full Slots that can Fit in Each DL and UL Slot

In the legacy TDD frame structure, the guard time between two legacy UL slots is 0.22 ms, and each legacy UL slot is 8.28 ms. If we add the additional 0.28 ms with the guard time 0.22 ms, a guard period between two 8 ms IoT NTN UL timeslots will be 0.5 ms, which is exactly a slot length or half a subframe. Also, the UL frame structure for NB-IoT is based on slots, slot level alignment can be perfect for IoT NTN UL.

However, the guard time between two legacy DL slots is only 0.1 ms, different shifts at different DL slots are necessary to even make the guard time to become 0.5 ms. And the aggregated shift may result in a longer guard time in some cases.

In general, if the alignment granularity is changed to an LTE slot length, i.e. 0.5 ms, the resulting IoT NTN DL or UL timeslot may have better fit than alignment with full subframe granularity.

Without considering shift, even with slot level alignment, all IoT NTN UL timeslots will have 7 full subframes only. All IoT UL timeslots are only 0.06 ms short at the beginning to have 8 full subframes, virtually one symbol missing to confine in the legacy UL slots. Thus, some shift or offset may be beneficial to ensure the required number of subframes can be allocated. Alternatively, the shift can be performed by indicating a TA offset for the transmissions in a UL slot. With the additional shift, all guard time between IoT NTN UL timeslots will be 0.5 ms.

With 0.5 ms guard time between IoT NTN DL timeslots, IoT NTN DL2, DL3 and DL4 timeslots can have full 8 ms with 16 full LTE slots. IoT NTN DL1 is 0.08 ms at the beginning outside the legacy TDD DL1 region, i.e. two symbols are lost at the beginning. However, if the first subframe is used for NPBCH transmission in every IoT NTN TDD DL timeslot, the first 3 symbols in a IoT NTN DL timeslot will not be used, thus, the 0.08 ms loss in IoT NTN DL1 timeslot may not be an issue.

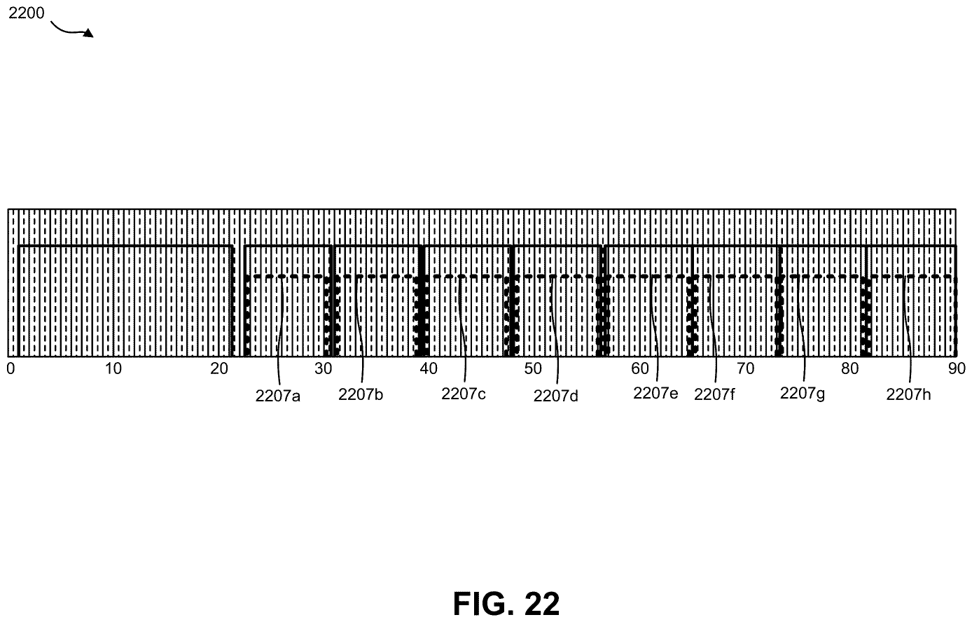

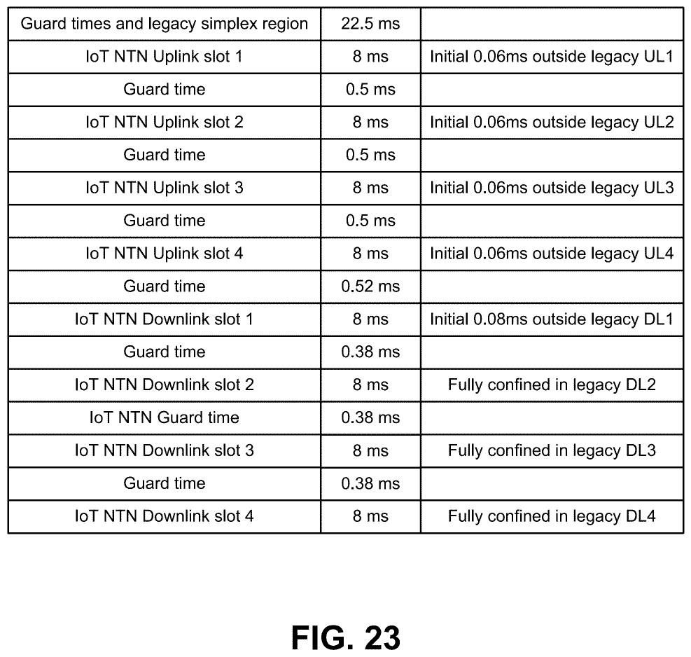

FIG. 22 shows the result with nearest slot alignment. FIG. 22 is a diagram 2200 illustrating an example of IoT NTN UL timeslots and IoT NTN DL timeslots with nearest slot alignment. The relative positions in relation to a 90 ms period are given below. Boxes 2207a-2207h are the resulting IoT NTN DL and UL timeslots. As shown in FIG. 22 and FIG. 23, all IoT NTN UL timeslots are initially offset by 0.06 ms outside the legacy TDD UL slots, and the IoT NTN DL1 timeslot is initially offset by 0.08 ms outside the legacy TDD DL1 slot.

FIG. 23 is a table illustrating an example of IoT NTN TDD timeslots with nearest LTE slot alignment. The resulting IoT NTN timeslots are much better than subframe level alignment, almost all IoT NTN TDD timeslots have 8 ms with 16 full slots, and all guard time as 0.5 ms. However, in some IoT NTN DL timeslots, i.e. DL1 and DL3, the resulting IoT NTN DL timeslot starts at slot boundary in the middle of a subframe. Thus, in order to reuse the NB-IoT subframe structure, an LTE slot shift is required in these IoT NTN DL timeslots, i.e. the IoT NTN DL subframe actually starts in the middle of an LTE subframe and ends in the middle of the next LTE subframe. This will cause some changes to existing LTE frame structure.

Method 4: An IoT NTN DL or UL Timeslot with LTE Slot Boundary Alignment with Symbol Offset for Different Slots

To better align the IoT NTN TDD DL and UL slots with the legacy DL and UL slots, some shift or offset values can be added to the sets of 8 subframes.

Since there are gaps between the slots, the offset of transmission will not break the beam switching and beam set operations. The resulting DL and UL set should have 8 full subframes that are fully confined within legacy DL and UL slots.

Without destroying the LTE frame and symbol structure, the offset can be in a number of symbols.
For UL timeslots, one LTE symbol delay offset (move later with the offset) can put all IoT NTN UL timeslots within the legacy TDD UL slots. A two LTE symbol delay offset can put all IoT NTN UL timeslots almost at the center of the legacy TDD UL slots.
For DL timeslots, no offset may be necessary considering the slot level alignment and the first 3 symbols in a DL timeslot may not be used. However, a two symbol delay offset can make sure IoT NTN DL1 is fully confined in the legacy DL1. Additionally, a one symbol or two symbol forward offset (move earlier with the offset) for DL2, DL3, and DL4 can let the resulting IoT NTN DL timeslots fit better at the center of the legacy DL slots.
The guard times between the resulting timeslots will be different when offsets are applied. To make sure the 90 ms period is not changed, if delay offset is applied to the UL timeslots, the same amount of forward offset should be applied to one or more DL timeslots.

The offset values for each IoT NTN DL timeslot or IoT NTN UL timeslot can be configured, pre-defined, or fixed. The same offset value may be applied for all UL timeslots. The offset can be a configured, pre-defined, or fixed value for each IoT NTN DL timeslots. Different offset values may be applied for different IoT NTN DL timeslots.

The offset values may be other values instead of an integer number of symbols. Again, to make sure the 90 ms period is not changed, if delay offset is applied to the UL timeslots, the same amount of forward offset should be applied to one or more DL timeslots.

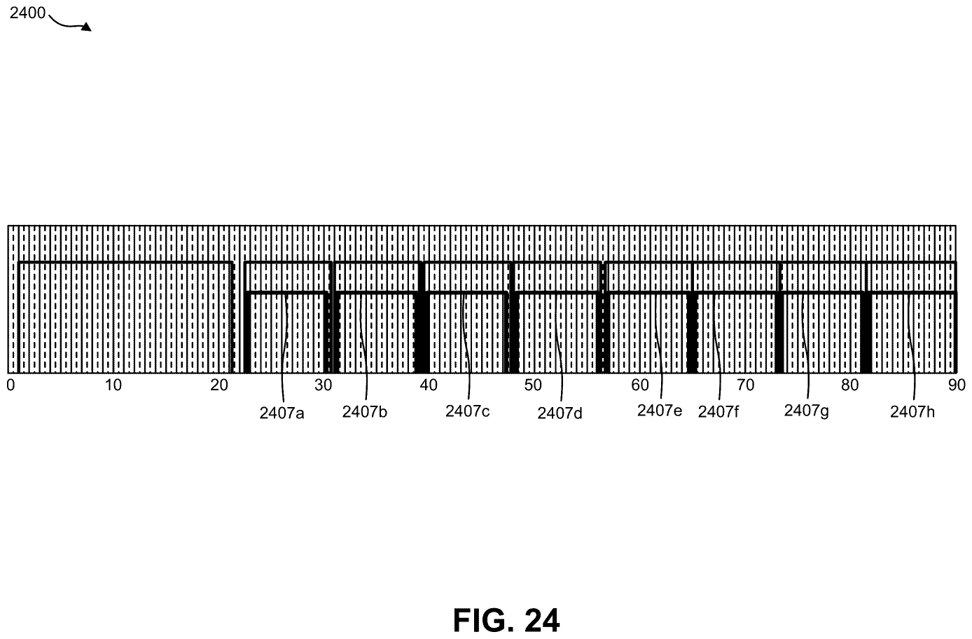

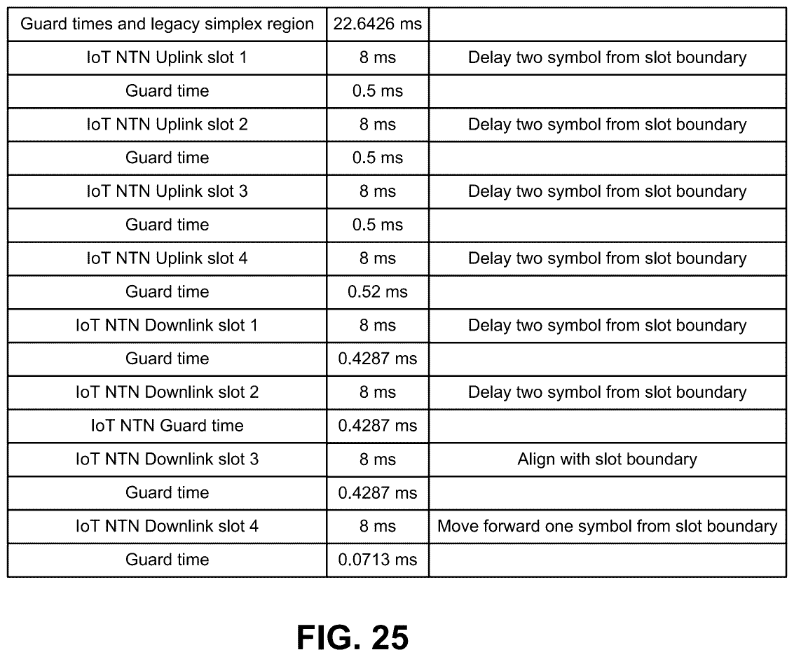

FIG. 24 and FIG. 25 show one example of slot alignment with offsets at IoT NTN DL and IoT NTN UL timeslots with a number of LTE symbols. FIG. 24 is a diagram 2400 illustrating an example of IoT NTN UL timeslots and IoT NTN DL timeslots with slot alignment and symbol level offsets. The resulting IoT NTN timeslots, shown in boxes 2407a-2407 h in FIG. 24, all have 8 ms durations fully confined in the legacy TDD slots. The IoT NTN UL timeslots are delayed by two symbols to fit in the center of the legacy UL slots. The IoT NTN DL timeslots are shifted so that the guard times between two adjacent DL timeslots is one symbol shorter than a slot.

FIG. 25 is a table illustrating an example of IoT NTN TDD timeslots with nearest LTE slot alignment and symbol offsets.

With LTE slot level alignment, especially with symbol offsets, the IoT NTN DL and UL timeslots have full 8 ms fully confined within legacy TDD slots, and the remaining overlapping partial LTE subframes or LTE symbols are very limited, up to 3 symbols only, and can be ignored. This provides a clean design with unified structure in all IoT NTN DL timeslots and IoT NTN UL timeslots.

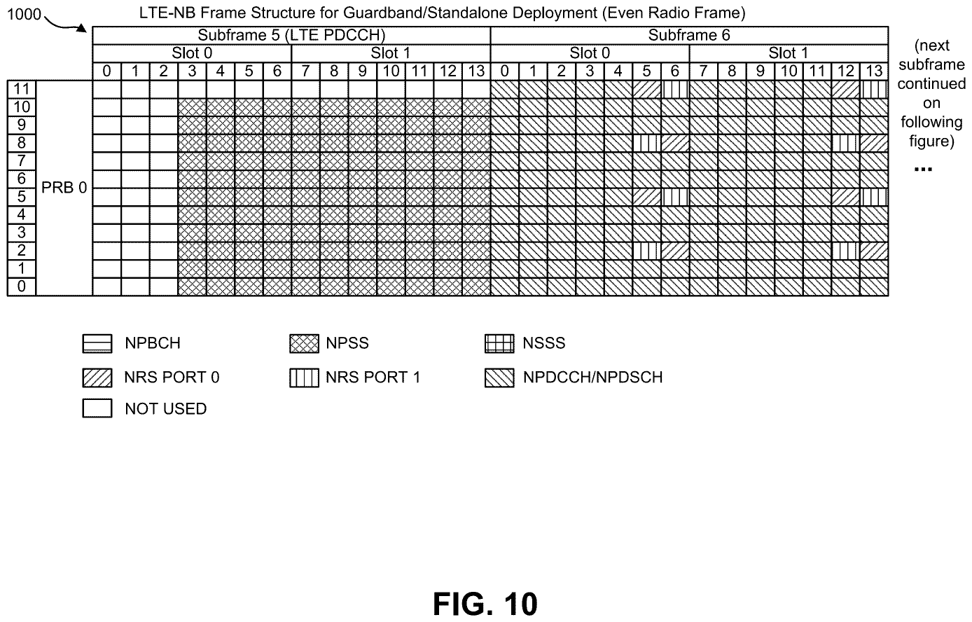

In all methods, the detailed position of each IoT NTN DL timeslot and each IoT NTN UL timeslot in relative to the beginning of the IoT NTN TDD 90 ms period should be specified. Moreover, traditionally, an LTE or an NR TDD structure starts with downlink allocations, followed by a gap or guard time for DL to UL transition considering the time advances at the UE side, followed by UL allocations. Therefore, regardless of which method is used to derive the IoT NTN DL timeslots and IT NTN UL timeslots, the same logic can be applied to IoT NTN TDD design, so that an IoT NTN TDD period may have an offset time from the legacy L-band TDD, as shown in FIG. 10. The detailed position of each IoT NTN DL timeslot and each IoT NTN UL timeslot in relation to the beginning of the IoT NTN TDD 90 ms period should also be specified together with the offset value. If the period offset is applied, the relative positions for each IoT NTN DL timeslot and each IoT NTN UL slot should be modified accordingly.

The period offset is mainly controlled by the gNB and satellites assuming the legacy TDD frame synchronization and operation is known. On the other hand, an IoT NTN device may not have the capability to detect the legacy L-band transmissions, thus no knowledge of legacy TDD information. An IoT NTN TDD device may follow the 90 ms period structure for IoT NTN TDD structure only.

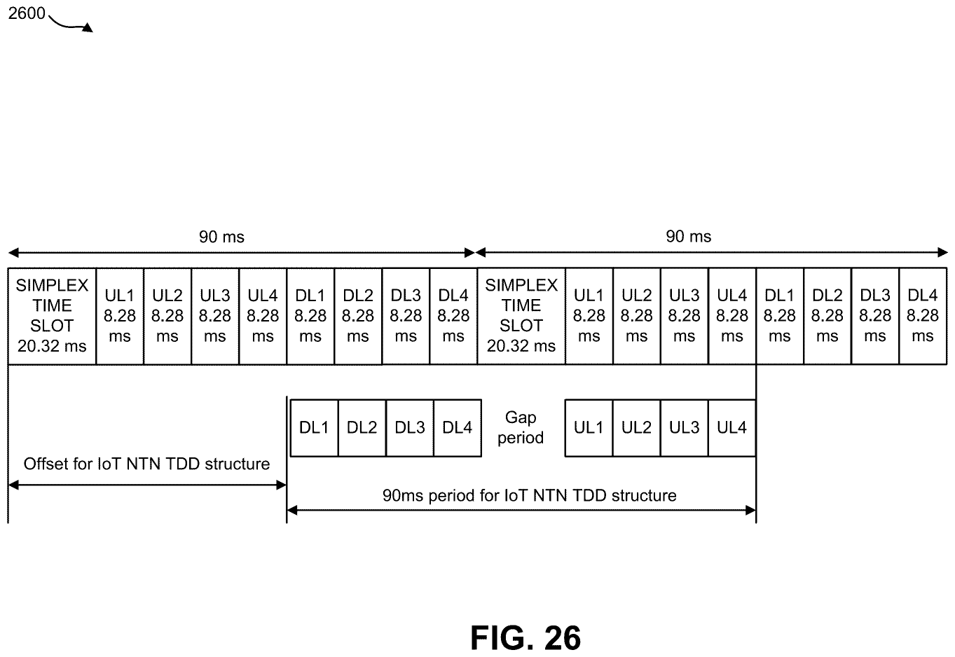

FIG. 26 is a diagram 2600 illustrating an example of different period starting points for IoT NTN TDD periods with an offset. With the shifted starting point for IoT NTN TDD, the corresponding IoT NTN DL timeslots and IoT NTN UL timeslots in a period k may determine the default timing within the same 90 ms period k. For example, an UL grant in DL #n schedules an PUSCH transmission in UL #n in the same period, and a DL PDSCH in DL #n will expect a HARQ-ACK reporting in UL #n, where n is from 1 to 4 for DL1 to DL4, and UL1 to UL4 respectively.

If there's no offset for the starting point of the IoT NTN TDD period, the IoT NTN UL timeslots are in front of the IoT NTN DL slots, and the timing relationship would be shifted to the next period. For example, a UL grant in DL #n in a period k schedules an PUSCH transmission in UL #n of the next period, i.e, period k+1, and a DL PDSCH in DL #n in a period k will expect a HARQ-ACK reporting in UL #n of the period k+1.

### Issue 2: Synchronization Signal Design for IoT NTN TDD

In legacy NB-IoT, the NPSS and NSSS are located in different subframes. The NPSS is transmitted in every radio frame, i.e. every 10 ms, but NSSS is transmitted in every two radio frames on the even frames only, i.e. every 20 ms. The NPBCH carries the critical information for the cell, and thus can be considered together with synchronization signals. The NPSS is transmitted in every radio frame, i.e. every 10 ms. The NPBCH is in subframe 0 of every radio frame, NPSSS is in subframe 5 of every radio frame, and NSSS is in subframe 9 of an even radio frame.

To support IoT NTN TDD operation, the synchronization signals should be detected first by the devices. With IoT NTN TDD, all downlink NB-IoT channels/signals in a cell can only use one of the downlink slots in the TDD frame structure (DL1, DL2, DL3 or DL4) across 90 ms periods, and the same downlink slot is used in all the 90 ms periods. All uplink NB-IoT channels in a cell can only use one of the uplink slots in the TDD frame structure (UL1, UL2, UL3, or UL4) across 90 ms periods, and the same uplink slot is used in all the 90 ms periods. The one uplink slot and one downlink slot in the TDD frame structure have the same index (DL1 & UL1, DL2 & UL2, DL3 & UL3, or DL4 & UL4). Therefore, an IoT NTN device in a cell can only receive DL signals from one IoT NTN DL timeslot in every 90 ms period, and can only transmit in one IoT NTN UL timeslot with the same index.

There are no more than 8 full subframes that can fit in each legacy TDD DL slot, and D=8 is the baseline for the IoT NTN TDD synchronization structure. Therefore, the current NB-IoT synchronization structure should be modified to fit into an IoT NTN DL timeslot.
If the radio frame structure is already broken, an IoT NTN DL timeslot may not align with a legacy LTE radio frame. And there are no continuous radio frames in LTE, and guard times with fractional subframe lengths are present between different IoT NTN DL timeslots.
Since there is a maximum of 8 full subframes in an IoT NTN DL timeslot, the last subframe in a radio frame, i.e. subframe 9, is not available for NSSS transmission. Thus, the NSSS should be relocated to a different subframe in the IoT NTN DL timeslot.
NPSS is in subframe 5 of a radio frame. With a broken radio frame and a smaller number of subframes in an IoT NTN DL timeslot, the location of the NPSS may need to be updated for better time domain distribution.

The device can only receive from one of the four DL slots in every 90 ms period, so the synchronization acquisition time should be considered to determine the required density of each synchronization signal. The legacy NB-IoT design can be reused for the content and resource mapping of NPBCH, the NPSS and NSSS sequences and resource mapping in a subframe.

Thus, the design of IoT NTN TDD synchronization signal will focus on the location mapping of these signals. The IoT-NTN TDD synchronization signal positions in an IoT NTN DL timeslot should be determined first for the synchronization signal mapping.

### Aspect 1: The Relative Location of Synchronizations Signals in an IoT NTN DL Timeslot

NPBCH may be allocated in the first subframe (subframe 0) of an IoT NTN DL timeslot. This is similar to legacy NB-IoT where the NPBCH is in the first subframe of every radio frame. However, with IoT NTN TDD, the radio frame is not aligned with the IoT NTN DL timeslot. The subframe 0 refers to the first full subframe in an IoT NTN DL timeslot. Depending on how the IoT NTN timeslots are defined, the first full subframe may be defined differently.
If full subframe alignment is used to determine the IoT NTN DL timeslot, the first full subframe should align with LTE subframe boundary. Thus, the beginning of an IoT NTN DL timeslot may be a partial subframe and cannot be used for NPBCH transmission.
Similarly, if slot boundary alignment is used to determine the IoT NTN DL timeslot, the first full subframe should align with LTE slot boundary. Thus, in some IoT NTN DL timeslots, the NPBCH subframe may start from the middle of an LTE subframe and end in the next LTE subframe. Again, the beginning of an IoT NTN DL timeslot may be a partial subframe and cannot be used for NPBCH transmission.
In some cases, if the first subframe in an IoT NTN DL timeslot is short of 1 or 2 symbol spaces, the subframe can be treated as full subframe for NPBCH transmission because the first 3 symbol are not used for NPB CG transmission.
If symbol offset may be applied, the subframe may start immediately in the defined IoT NTN DL timeslot. In this case, the first subframe is used for the NPBCH transmission. However, the IoT NTN DL timeslot may not align with the legacy LTE subframe or slot boundaries.

NPSS is in subframe 5 of a radio frame in legacy LTE NB-IoT. However, with IoT NTN TDD, the radio frame is not aligned with the IoT NTN DL timeslot. The subframe index refers to the full subframe in an IoT NTN DL timeslot. Depending on how the IoT NTN timeslots are defined, the number of full subframes in an IoT NTN DL timeslot may have 8 full subframes or only 7 full subframes. The different cases to determine the full subframes in an IoT NTN DL timeslot are the same as described above for the NPBCH.

In one approach (Approach 1), the NPSS can be mapped to subframe 5 in an IoT NTN DL timeslot to maintain the same relative distance between the NPBCH and NPSS.

In another approach (Approach 2), since there are up to 8 full subframes in an IoT NTN DL timeslot, the NPSS can be mapped subframe 4 instead to make it in the middle of the IoT NTN DL timeslot. This provides better distance distribution for the synchronization signals.

Alternatively, the NPSS can be mapped to subframe 3 and still provide better distance distribution than legacy subframe 5, especially if there are only 7 full DL subframes in an IoT NTN DL timeslot, moving the NPSSS to subframe 4 or subframe 3 could be beneficial.

In one option, the same NPSS location is used in the same subframe index in an IoT NTN DL timeslot, e.g. always in subframe 4 in an IoT NTN DL timeslot. In another option, different NPSS locations may be used depending on the number of full subframes in an IoT NTN DL timeslot. For example, if there are 8 full subframes, subframe index 4 is used, and if there are only 7 full subframes, subframe index 3 is used; or if there are 8 full subframes, subframe index 5 is used, and if there are only 7 full subframes, subframe index 4 is used.

NSSS is in subframe 9 of even radio frames in legacy LTE NB-IoT. However, with IoT NTN TDD, the radio frame is not aligned with the IoT NTN DL timeslot. The subframe index refers to the full subframe in an IoT NTN DL timeslot. Also, the UE can detect only one IoT NTN DL timeslot in every 90 ms period. Thus, NSSS location in an IoT NTN DL timeslot should be specified with a new subframe index within an IoT NTN DL timeslot. Depending on how the IoT NTN timeslots are defined, the number of full subframes in an IoT NTN DL timeslot may have 8 full subframes or only 7 full subframes. The different cases to determine the full subframes in an IoT NTN DL timeslot are the same as described above for the NPBCH.

In one alternative (Alt. 1), if there are 8 full subframes in an IoT NTN DL timeslot, the NSSS can be mapped to subframe 7, i.e. the last full subframe, in the IoT NTN DL timeslot. However, if there are only 7 full subframes in an IoT NTN DL timeslot, the NSSS can only be mapped to subframe 6, i.e. the last full subframe, in the IoT NTN DL timeslot. Thus, depending on how the IoT NTN DL timeslots are defined, the NSSS mapping location may be different in different SL timeslots.

To simplify the NSSS mapping, another alternative (Alt. 2) may be used to always map the NSSS to subframe 6 if the number of full subframes may be different in different IoT NTN DL timeslots. This provides a consistent relative distance between the synchronization signals, i.e. between NPBCH, NPSS and NSSS.

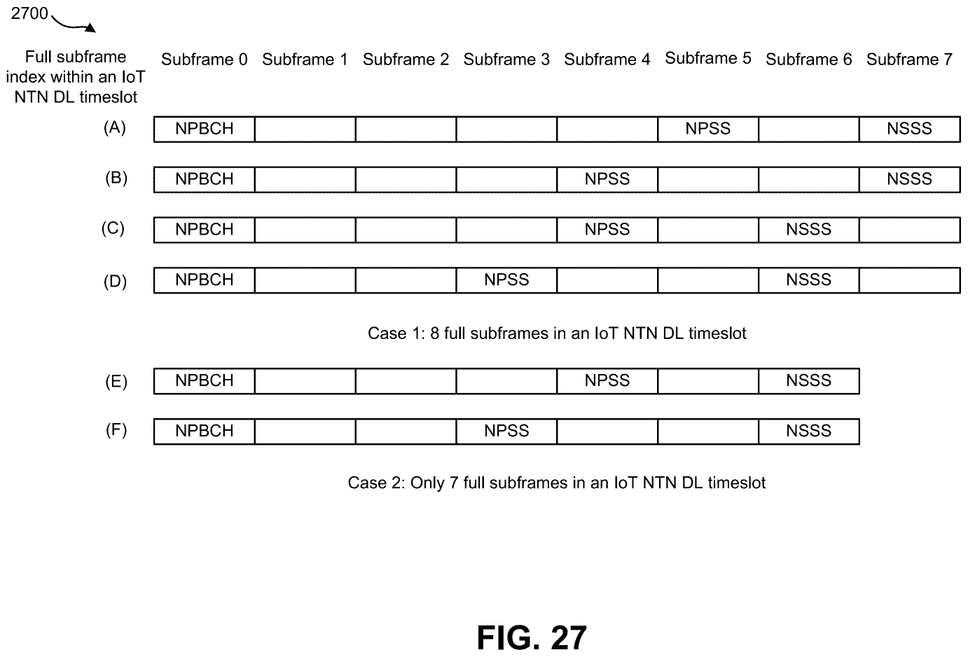

FIG. 27 is a diagram 2700 illustrating an example of synchronization signal mapping in an IoT NTN DL timeslot. FIG. 27 shows several examples of synchronization mapping for NPBCH, NPSS, and NSSS in an IoT NTN DL timeslot. In one case (Case 1) when 8 full subframes are available in an IoT NTN DL timeslot:
FIG. 27 (A) is an example where the NPBCH, NPSS, and NSSS are mapped to subframe index 0, 5, and 7 respectively. This maintains the relative position of NBPCH and NPSS as in legacy NB-IoT, but the NSSS is moved to subframe 7 in the IoT NTN DL timeslot.
FIG. 27 (B) is an example where the NPBCH, NPSS, and NSSS are mapped to subframe index 0, 4, and 7 respectively. The NPSS is moved to an earlier subframe compared with legacy NB-IoT. And the NSSS is in subframe 7 in the IoT NTN DL timeslot.
FIG. 27 (C) is an example where the NPBCH, NPSS, and NSSS are mapped to subframe index 0, 4, and 6 respectively. The NPSS is moved to an earlier subframe compared with legacy NB-IoT. And the NSSS is in subframe 6 in the IoT NTN DL timeslot to be compatible with the case with 7 full subframes only.
FIG. 27 (D) is an example where the NPBCH, NPSS, and NSSS are mapped to subframe index 0, 3, and 6 respectively. And the NSSS is in subframe 6 in the IoT NTN DL timeslot to be compatible with the case with 7 full subframes only. And the NPSS is moved further earlier to provide better distance distribution between synchronization signals.

In another case with full subframe or slot level alignment, some IoT NTN DL timeslots may have only 7 full subframes available.
FIG. 27 (E) is an example where the NPBCH, NPSS, and NSSS are mapped to subframe index 0, 4, and 6 respectively. The NPBCH is still in the first full subframe, but the relative positions of NPSS and NSSS are changed. The NSSS is in subframe 6 in the IoT NTN DL timeslot since there are only 7 full subframes available, and NSSS is mapped to the last full subframe in the IoT NTN DL timeslot.
FIG. 27 (F) is an example where the NPBCH, NPSS, and NSSS are mapped to subframe index 0, 3, and 6 respectively. The NPSS is moved to an earlier subframe compared with legacy NB-IoT. And the NSSS is in subframe 6 in the IoT NTN DL timeslot.

In one design, the same NPBCH, NPSSS, and NSSS positions are used in all IoT NTN DL slots. In another design, different NPBCH, NPSSS, and NSSS positions are used in different IoT NTN DL timeslots. This provides the benefit of identifying the timeslot index from the synchronization locations. For example, assume all IoT NTN DL timeslots have 8 full subframes, in IoT NTN timeslot DL1, the mapping in FIG. 27 (A) is applied, in IoT NTN timeslot DL2, the mapping in FIG. 27 (B) is applied, in IoT NTN timeslot DL3, the mapping in FIG. 27 (C) is applied, and in IoT NTN timeslot DL4, the mapping in FIG. 27 (D) is applied.

An IoT NTN TDD device can then determine the IoT NTN DL timeslot index based on the unique synchronization signal locations in the timeslot, and the corresponding IoT NTN UL timeslot. This is very critical for system operation because the distance between an IoT NTN DL timeslot and the corresponding IoT NTN UL timeslot is different for different timeslot indexes due to different guard time durations between different types of slots.

For example, with the IoT NTN TDD timeslot determination Method 4, the distance between the starting point of IoT NTN DL1 and the starting point of IoT NTN UL1 is 34 ms, the distance between the starting point of IoT NTN DL2 and the starting point of IoT NTN UL2 is 33.9287 ms, the distance between the starting point of IoT NTN DL3 and the starting point of IoT NTN UL3 is 33.8574 ms, and the distance between the starting point of IoT NTN DL3 and the starting point of IoT NTN UL3 is 33.7861.

If an IoT NTN TDD device does not know the timeslot index, it cannot determine what gap should be used between the DL timeslot and UL timeslot, and cannot transmit in the corresponding UL timeslot appropriately.

### Aspect 2: The Mapping of Synchronization Signals in Different IoT NTN DL Timeslots and Periods

Regardless of how the IoT-NTN TDD synchronization signal positions in an IoT NTN DL timeslot are applied, how to map the synchronization signals in different IoT NTN DL timeslots and different periods should be further specified.

The synchronization detection duration is at least 90 ms for one shot detection. Combining can be applied for the synchronization signals in multiple 90 ms periods to obtain desired signal quality for channel detection. Different synchronization signals, e.g. NPBCH, NPSS, and NSSS, may need a different number of combinations.

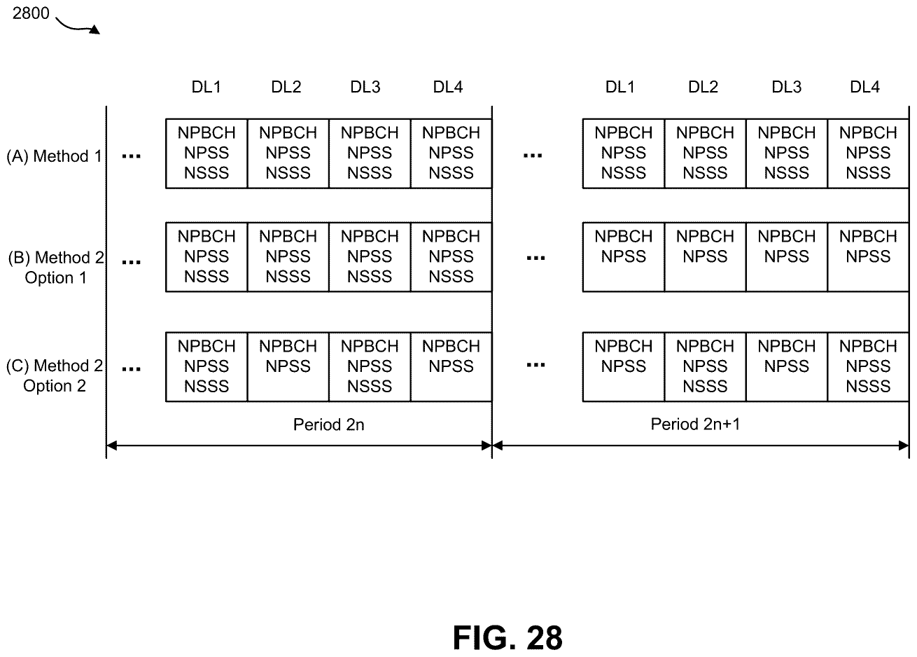

Depending on the synchronization detection requirements, several methods can be considered for IoT NTN synchronization signal design. FIG. 28 show some examples with different methods and options. FIG. 28 is a diagram 2800 illustrating an example of different mapping methods for NPSS and NSSS in different periods and DL timeslots.

### Method 1: NPBCH, NPSS and NSSS in Every IoT NTN DL Timeslot in a Period

If the detection time is very important, one shot detection in every 90 ms period may be desirable. In this case, the NPBCH, NPSS, and NSSS should be transmitted in every IoT NTN DL timeslot, as shown in FIG. 28 (A). The location mappings of these signals are discussed above. In FIG. 28 only the IoT NTN DL timeslots are shown, the IoT NTN UL timeslots, guard times, and simplex timeslots are ignored and represented by ellipsis.

This provides best synchronization signal detection performance. However, it has more signal overhead since 3 subframes are occupied for synchronization signals only in each IoT NTN DL timeslot where only 8 subframes are available.

### Method 2: NPBCH, NPSS in Every Period, and NSSS in Every Two Periods for an IoT NTN DL Timeslot

To reduce the synchronization signal overhead, the density of the synchronization signals may be reduced, especially for NSSS. Thus, in another method, the NPBCH and NPSS may be transmitted in an IoT NTN DL timeslot in every 90 ms period, and NSSS may be transmitted in an IoT NTN DL timeslot every two 90 ms periods. This provides the same relative ratio between NPSS and NSSS transmissions as in legacy NB-IoT.

In one Option (Option 1), for all IoT NTN DL timeslots, the NSSS is present in 90 ms periods with an even number of period indexes (i.e. periods with indexes 2n), and NSSS is not present in 90 ms periods with an odd number of period indexes (i.e. periods with indexes 2n+1), as shown in FIG. 28 (B). And vice versa, i.e. the NSSS is present in 90 ms periods with an odd number of period indexes, and NSSS is not present in 90 ms periods with an even number of period indexes. With this option, if present, the NSSS is transmitted in all IoT NTN DL timeslots in a given period. Thus making the synchronization consistent among all IoT devices in different IoT NTN DL slots.

On the other hand, from system point of view, more resources are used for synchronization and less resources are available for data transmissions in one period, and less resources are used for synchronization and more resources are available for data transmissions in another period. The overall system traffic rate will be unbalanced with variations in different 90 ms periods.

Thus, in another Option (Option 2), the NSSS present are alternatively switched between different IoT NTN DL timeslots in a 90 ms period. The NSSS is present in every period but not every IoT DL timeslot in a period, as shown in FIG. 28 (C). For example, in 90 ms periods with an even number of period indexes, the NSSS is present in IoT NTN DL1 and DL3 timeslots and NSSS is not present in IoT NTN DL2 and DL4 timeslots. In 90 ms periods with an odd number of period indexes, the NSSS is present in IoT NTN DL2 and DL4 timeslots and NSSS is not present in IoT NTN DL1 and DL3 timeslots. Or vice versa, i.e. in 90 ms periods with an odd number of period indexes, the NSSS is present in IoT NTN DL1 and DL3 timeslots and NSSS is not present in IoT NTN DL2 and DL4 timeslots. In 90 ms periods with an even number of period indexes, the NSSS is present in IoT NTN DL2 and DL4 timeslots and NSSS is not present in IoT NTN DL1 and DL3 timeslots.

Other combinations may also be considered with the same principle, e.g. NSSS is present in DL1 and DL2 only in one period, and NSSS is present in DL3 and DL4 only in the next period. Option 2 ensures constant usable resources in each period, and provides a more stable aggregated traffic rate in the system. Additionally, the IoT device may determine its IoT NTT timeslot index based on the presence of the NSSS signals, e.g. DL1 and DL3 from DL2 and DL4. To further differentiate the timeslot index, some variations of NPBCH, NPSS, NSSS mapping in a timeslot can be further applied as discussed before. Some staggered NPBCH/NPSS/NSSS mapping in different IoT NTN TDD 90 ms periods can also be applied so that each DL timeslot can be identified based on a unique NPBCH/NPSS/NSSS mapping in multiple periods.

Other signal densities may be considered, e.g. the densities of NPBCH may be different from the density of NPSS, and more subframes may be allocated for NPBCH to reduce the delay for master information block (MIB) detection.

In the above, the legacy NB-IoT standalone deployment mapping in a subframe is used for NPBCH, NPSS, and NSSS in an IoT NTN DL timeslot. In the mapping, the first 3 symbols in the mapped subframe are not used. This is to reserve the symbols for legacy LTE PDCCH region.

Additionally or alternatively, considering the period of 90 ms for IoT NTN TDD, and there is no legacy LTE in the target frequency band, the first 3 symbols in the mapped subframes for NPBCH and/or NPSS and/or NSSS may be used for IoT NTN TDD. In this case, the NPBCH may have more resource elements for the SIB information, thus can improve the NPBCH reliability and detection. Similarly, longer sequences can be mapped for NPSS and NSSS in the corresponding subframes for performance enhancement. If all 3 symbols are used, there are 27% more resources than legacy resource mapping. Since there is a guard period before each IoT NTN DL timeslot, the 3 unused symbols do not provide additional better synchronization detection by the gap formed by the unused symbols.

The additional number of symbols for mapping may not occupy all unused symbols. For example, if only one additional symbol is used for mapping of NPBCH/NPSS/NSSS, only the first two symbols in the mapped subframes are not used, and the resource is increased by 9% compared with legacy resource mapping. If two additional symbols are used for mapping of NPBCH/NPSS/NSSS, only the first symbol in the mapped subframes are not used, and the resource is increased by 18% compared with legacy resource mapping.

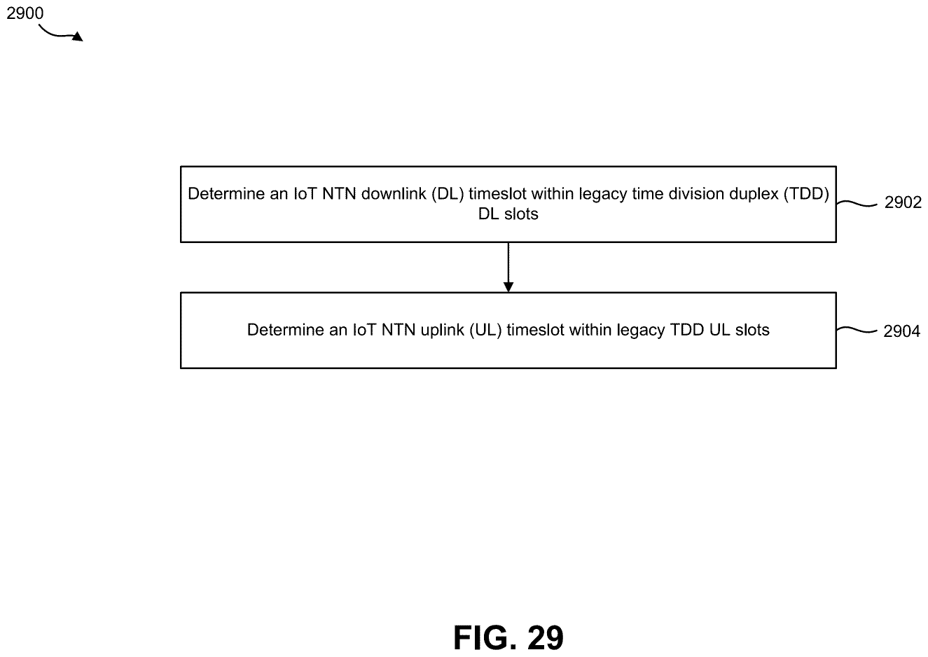

FIG. 29 is a flow diagram illustrating an example of a communication method 2900 by an IoT NTN device UE. The method may determine 2902 an IoT NTN downlink (DL) timeslot within legacy time division duplex (TDD) DL slots. The method may also determine 2904 an IoT NTN uplink (UL) timeslot within legacy TDD UL slots.

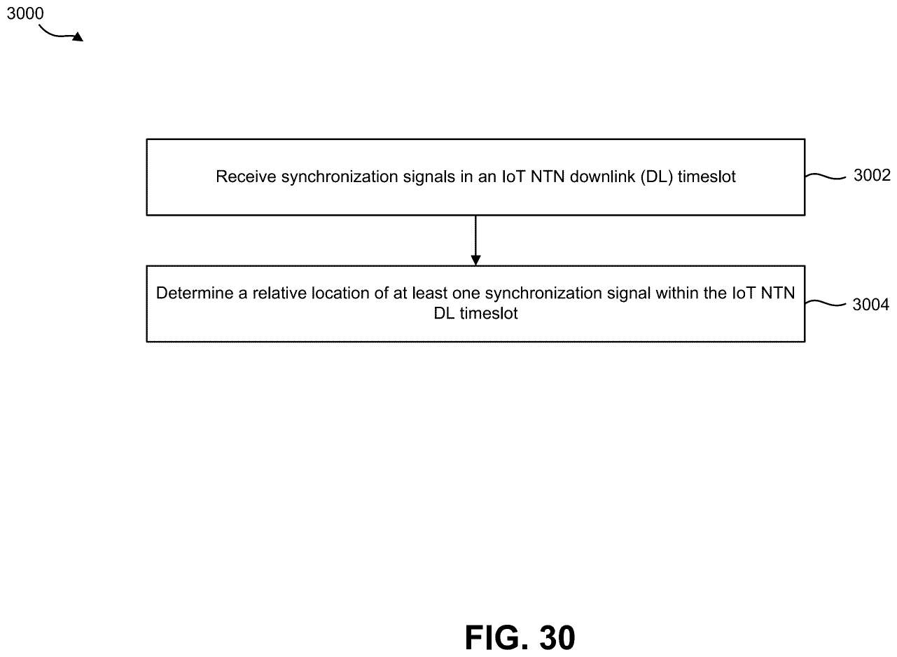

FIG. 30 is a flow diagram illustrating another example of a communication method 3000 by an IoT NTN device UE. The method may receive 3002 synchronization signals in an IoT NTN downlink (DL) timeslot. The method may determine 3004 a relative location of at least one synchronization signal within the IoT NTN DL timeslot.

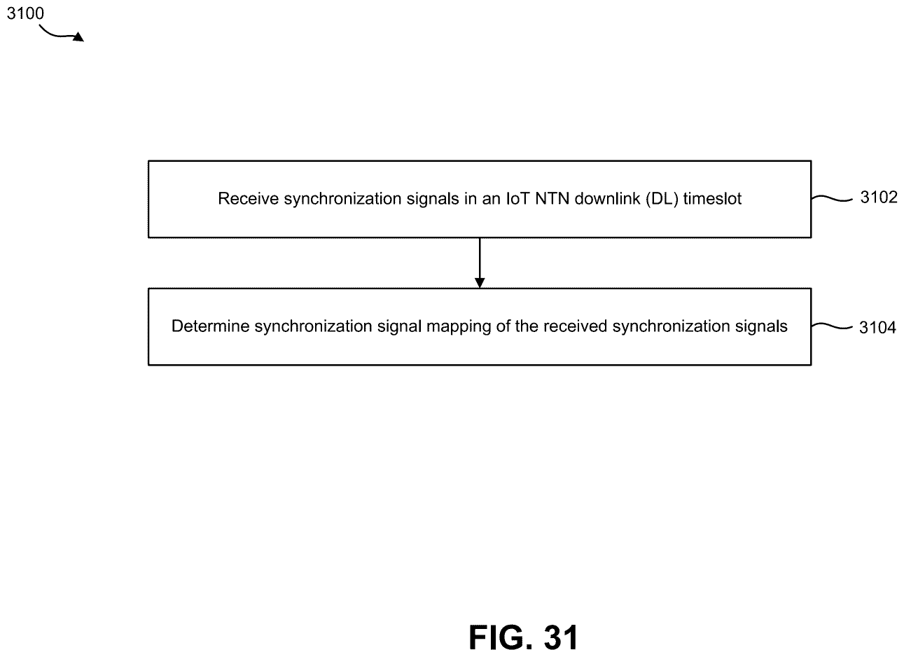

FIG. 31 is a flow diagram illustrating another example of a communication method 3100 by an IoT NTN device UE. The method may receive 3102 synchronization signals in an IoT NTN downlink (DL) timeslot. The method may determine 3104 synchronization signal mapping of the received synchronization signals.

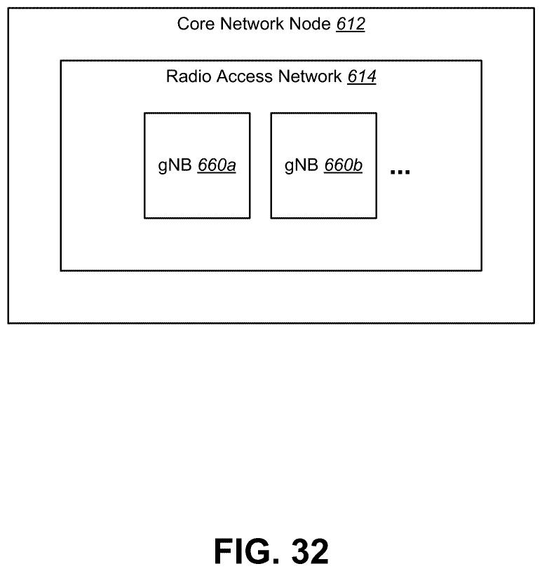

FIG. 32 is block diagram illustrating one implementation of a core network node 612. The core network node 612 may include a radio access network 614 that includes a plurality of gNBs (gNB 660a, 660b). Messages transmitted and received by the core network node 612 may be transmitted and received by the gNBs 660a, 660b in the radio access network 614. The core network node 612 may be part of the 5GC 118 or the NG-RAN 102.

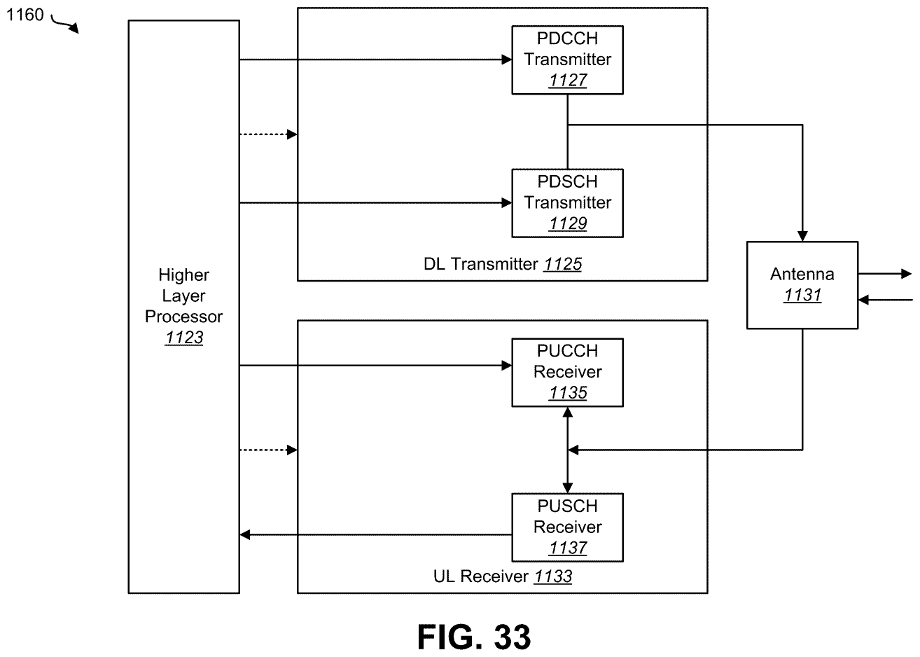

FIG. 33 is a block diagram illustrating one implementation of a eNB 1160. The eNB 1160 may include a higher layer processor 1123, a DL transmitter 1125, a UL receiver 1133, and one or more antenna 1131. The DL transmitter 1125 may include a PDCCH transmitter 1127 and a PDSCH transmitter 1129. The UL receiver 1133 may include a PUCCH receiver 1135 and a PUSCH receiver 1137.

The higher layer processor 1123 may manage physical layer's behaviors (the DL transmitter's and the UL receiver's behaviors) and provide higher layer parameters to the physical layer. The higher layer processor 1123 may obtain transport blocks from the physical layer. The higher layer processor 1123 may send and/or acquire higher layer messages such as an RRC message and MAC message to and/or from a wireless terminal's higher layer. The higher layer processor 1123 may provide the PDSCH transmitter transport blocks and provide the PDCCH transmitter transmission parameters related to the transport blocks.

The DL transmitter 1125 may multiplex downlink physical channels and downlink physical signals (including reservation signal) and transmit them via transmission antennas 1131. The UL receiver 1133 may receive multiplexed uplink physical channels and uplink physical signals via receiving antennas 1131 and de-multiplex them. The PUCCH receiver 1135 may provide the higher layer processor 1123 Uplink Control Information (UCI). The PUSCH receiver 1137 may provide the higher layer processor 1123 received transport blocks.

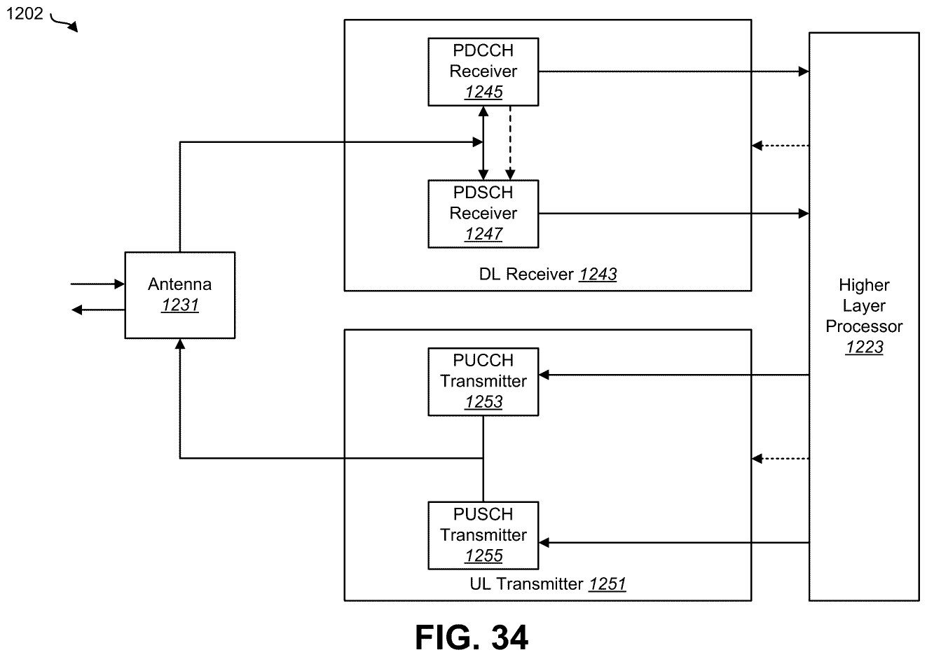

FIG. 34 is a block diagram illustrating one implementation of a wireless terminal 1202. In some examples, the wireless terminal 1202 is a UE. The wireless terminal 1202 may include a higher layer processor 1223, a UL transmitter 1251, a DL receiver 1243, and one or more antenna 1231. The UL transmitter 1251 may include a PUCCH transmitter 1253 and a PUSCH transmitter 1255. The DL receiver 1243 may include a PDCCH receiver 1245 and a PDSCH receiver 1247.

The higher layer processor 1223 may manage physical layer's behaviors (the UL transmitter's and the DL receiver's behaviors) and provide higher layer parameters to the physical layer. The higher layer processor 1223 may obtain transport blocks from the physical layer. The higher layer processor 1223 may send and/or acquire higher layer messages such as an RRC message and MAC message to and/or from a wireless terminal's higher layer. The higher layer processor 1223 may provide the PUSCH transmitter transport blocks and provide the PUCCH transmitter 1253 UCI.

The DL receiver 1243 may receive multiplexed downlink physical channels and downlink physical signals via receiving antennas 1231 and de-multiplex them. The PDCCH receiver 1245 may provide the higher layer processor 1223 DCI (Downlink Control Information). The PDSCH receiver 1247 may provide the higher layer processor 1223 received transport blocks.

It should be noted that names of physical channels described herein are examples. The other names such as “NRPDCCH, NRPDSCH, NRPUCCH and NRPUSCH”, “new Generation-(G) PDCCH, GPDSCH, GPUCCH and GPUSCH” or the like can be used.

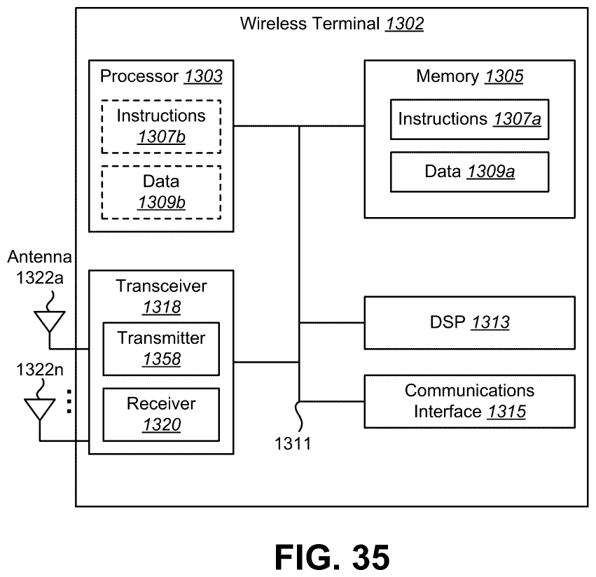

FIG. 35 illustrates various components that may be utilized in a wireless terminal 1302. In some examples, the wireless terminal 1302 is a UE. The wireless terminal 1302 described in connection with FIG. 35 may be implemented in accordance with the wireless terminal described herein. The wireless terminal 1302 includes a processor 1303 that controls operation of the wireless terminal 1302. The processor 1303 may also be referred to as a central processing unit (CPU). Memory 1305, which may include read-only memory (ROM), random access memory (RAM), a combination of the two or any type of device that may store information, provides instructions 1307a and data 1309a to the processor 1303. A portion of the memory 1305 may also include non-volatile random-access memory (NVRAM). Instructions 1307b and data 1309b may also reside in the processor 1303. Instructions 1307b and/or data 1309b loaded into the processor 1303 may also include instructions 1307a and/or data 1309a from memory 1305 that were loaded for execution or processing by the processor 1303. The instructions 1307b may be executed by the processor 1303 to implement the methods described above.

The wireless terminal 1302 may also include a housing that contains one or more transmitters 1358 and one or more receivers 1320 to allow transmission and reception of data. The transmitter(s) 1358 and receiver(s) 1320 may be combined into one or more transceivers 1318. One or more antennas 1322a-n are attached to the housing and electrically coupled to the transceiver 1318.

The various components of the wireless terminal 1302 are coupled together by a bus system 1311, which may include a power bus, a control signal bus and a status signal bus, in addition to a data bus. However, for the sake of clarity, the various buses are illustrated in FIG. 35 as the bus system 1311. The wireless terminal 1302 may also include a digital signal processor (DSP) 1313 for use in processing signals. The wireless terminal 1302 may also include a communications interface 1315 that provides user access to the functions of the wireless terminal 1302. The wireless terminal 1302 illustrated in FIG. 35 is a functional block diagram rather than a listing of specific components.

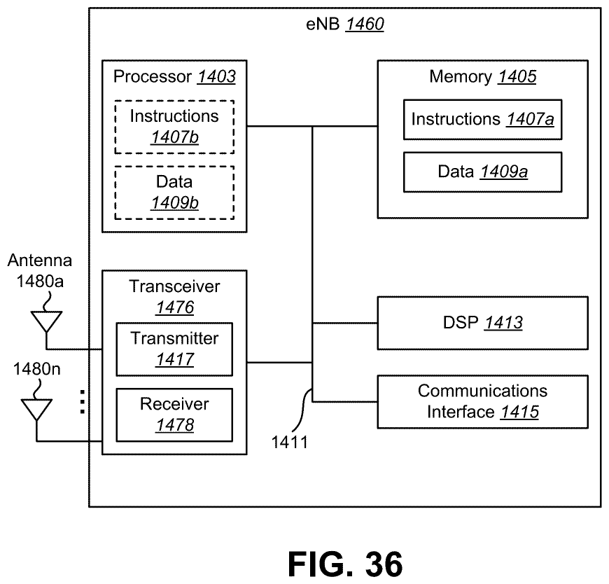

FIG. 36 illustrates various components that may be utilized in a eNB 1460. The eNB 1460 described in connection with FIG. 35 may be implemented in accordance with the eNB described herein. The eNB 1460 includes a processor 1403 that controls operation of the eNB 1460. The processor 1403 may also be referred to as a central processing unit (CPU). Memory 1405, which may include read-only memory (ROM), random access memory (RAM), a combination of the two or any type of device that may store information, provides instructions 1407a and data 1409a to the processor 1403. A portion of the memory 1405 may also include non-volatile random-access memory (NVRAM). Instructions 1407b and data 1409b may also reside in the processor 1403. Instructions 1407b and/or data 1409b loaded into the processor 1403 may also include instructions 1407a and/or data 1409a from memory 1405 that were loaded for execution or processing by the processor 1403. The instructions 1407b may be executed by the processor 1403 to implement the methods described above.

The eNB 1460 may also include a housing that contains one or more transmitters 1417 and one or more receivers 1478 to allow transmission and reception of data. The transmitter(s) 1417 and receiver(s) 1478 may be combined into one or more transceivers 1476. One or more antennas 1480a-n are attached to the housing and electrically coupled to the transceiver 1476.

The various components of the eNB 1460 are coupled together by a bus system 1411, which may include a power bus, a control signal bus and a status signal bus, in addition to a data bus. However, for the sake of clarity, the various buses are illustrated in FIG. 36 as the bus system 1411. The eNB 1460 may also include a digital signal processor (DSP) 1413 for use in processing signals. The eNB 1460 may also include a communications interface 1415 that provides user access to the functions of the eNB 1460. The eNB 1460 illustrated in FIG. 36 is a functional block diagram rather than a listing of specific components.

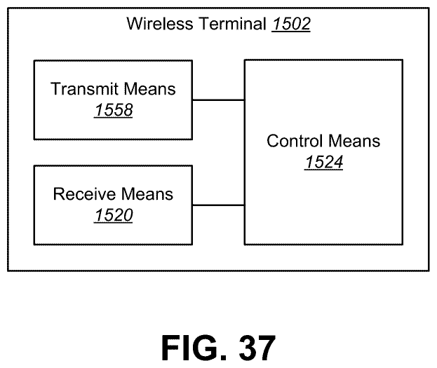

FIG. 37 is a block diagram illustrating one implementation of a wireless terminal 1502 in which systems and methods for resource allocations of enhanced uplink transmissions may be implemented. The wireless terminal 1502 includes transmit means 1558, receive means 1520 and control means 1524. The transmit means 1558, receive means 1520 and control means 1524 may be configured to perform one or more of the functions described herein. FIG. 35 above illustrates one example of a concrete apparatus structure of FIG. 37. Other various structures may be implemented to realize one or more of the functions herein. For example, a DSP may be realized by software.

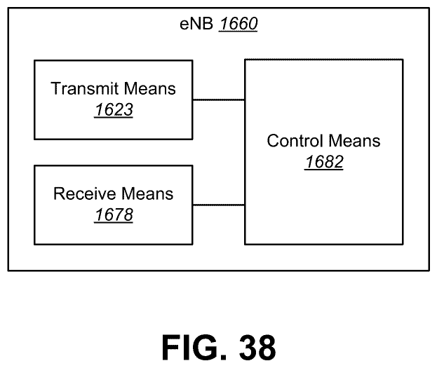

FIG. 38 is a block diagram illustrating one implementation of a eNB 1660 in which systems and methods for resource allocations of enhanced uplink transmissions may be implemented. The eNB 1660 includes transmit means 1623, receive means 1678, and control means 1682. The transmit means 1623, receive means 1678, and control means 1682 may be configured to perform one or more of the functions described herein. FIG. 36 above illustrates one example of a concrete apparatus structure of FIG. 38. Other various structures may be implemented to realize one or more of the functions described herein. For example, a DSP may be realized by software.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the systems, methods, and apparatus described herein without departing from the scope of the claims.

A program running on the gNB or the wireless terminal according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or Hard Disk Drives (HDDs), and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD, and the like), a magnetic storage medium (for example, a magnetic tape, a flexible disk, and the like), and the like, any one may be possible. Furthermore, in some cases, the function according to the described systems and methods described above is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the gNB and the wireless terminal according to the systems and methods described above may be realized as an LSI that is a typical integrated circuit. Each functional block of the gNB and the wireless terminal may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned implementations may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

As used herein, the term “and/or” should be interpreted to mean one or more items. For example, the phrase “A, B and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B and C” or the phrase “at least one of A, B or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

What is claimed is:

1. An internet of things (IoT) non-terrestrial network (NTN) device user equipment (UE), comprising:
receiving circuitry configured to:
determine an IoT NTN downlink (DL) timeslot within legacy time division duplex (TDD) DL slots; and
transmitting circuitry configured to:
determine an IoT NTN uplink (UL) timeslot within legacy TDD UL slots.

2. The UE of claim 1, wherein the IoT NTN DL timeslot and the IoT NTN UL timeslot are at the center of the legacy TDD DL and UL slots.

3. The UE of claim 1, wherein the IoT NTN DL timeslot or the IoT NTN UL timeslot includes full subframes that fit within the legacy TDD DL and UL slots.

4. The UE of claim 1, wherein the IoT NTN DL timeslot or the IoT NTN UL timeslot includes full slots that fit within the legacy TDD DL and UL slots.

5. The UE of claim 1, wherein the IoT NTN DL timeslot or the IoT NTN UL timeslot comprises a long-term evolution (LTE) slot boundary alignment with symbol offset for different slots.

6. The UE of claim 1, wherein a position of each IoT NTN DL timeslot and each IoT NTN UL timeslot is relative to the beginning of an IoT NTN TDD 90 millisecond (ms) period.

7. The UE of claim 6, wherein the IoT NTN TDD 90 ms period comprises an offset time from a legacy L-band TDD structure, such that the period starts with all IoT NTN DL timeslots and ends with all IoT NTN UL timeslots.

8. An e-NodeB (eNB), comprising:
transmitting circuitry configured to:
determine an internet of things (IoT) non-terrestrial network (NTN) downlink (DL) timeslot within legacy time division duplex (TDD) DL slots; and
receiving circuitry configured to:
determine an IoT NTN uplink (UL) timeslot within legacy TDD UL slots.

9. The eNB of claim 8, wherein the IoT NTN DL timeslot and the IoT NTN UL timeslot are at the center of the legacy TDD DL and UL slots.

10. The eNB of claim 8, wherein the IoT NTN DL timeslot or the IoT NTN UL timeslot includes full subframes that fit within the legacy TDD DL and UL slots.

11. The eNB of claim 8, wherein the IoT NTN DL timeslot or the IoT NTN UL timeslot includes full slots that fit within the legacy TDD DL and UL slots.

12. The eNB of claim 8, wherein the IoT NTN DL timeslot or the IoT NTN UL timeslot comprises a long-term evolution (LTE) slot boundary alignment with symbol offset for different slots.

13. The eNB of claim 8, wherein a position of each IoT NTN DL timeslot and each IoT NTN UL timeslot is relative to the beginning of an IoT NTN TDD 90 millisecond (ms) period.

14. The eNB of claim 13, wherein the IoT NTN TDD 90 ms period comprises an offset time from a legacy L-band TDD structure, such that the period starts with all IoT NTN DL timeslots and ends with all IoT NTN UL timeslots.

15. A method by an internet of things (IoT) non-terrestrial network (NTN) device user equipment (UE), comprising:
determining an IoT NTN downlink (DL) timeslot within legacy time division duplex (TDD) DL slots; and
determining an IoT NTN uplink (UL) timeslot within legacy TDD UL slots.
